(19) United States
(12) Patent Application Publication
(10) Pub. No.: US 2005/0054431 A1
(43) Pub. Date: Mar. 10, 2005

(54) Method and apparatus for providing instructions to gaming devices

(76) Inventors: Jay S. Walker, Ridgefield, CT (US); Bruce Schneier, Minneapolis, MN (US); James A. Jorasch, New York, NY (US); Andrew S. Van Luchene, Santa Fe, NM (US); Geoffrey M. Gelman, Stamford, CT (US); Michael D. Downs, Stamford, CT (US); Dean P. Alderucci, Westport, CT (US)

Correspondence Address: WALKER DIGITAL, FIVE HIGH RIDGE PARK, STAMFORD, CT, 06905, US

(21) Appl. No.: 10/922,063

(22) Filed: Aug. 19, 2004

Related U.S. Application Data
(63) Continuation-in-part of application No. 09/765,165, filed on Jan. 18, 2001, now Pat. No. 6,790,139.
Application No. 09/765,165 is a continuation of application No. 08/888,049, filed on Jul. 3, 1997, now Pat. No. 6,203,427.

(51) Int. Cl. A63F 13/00

(52) U.S. Cl. 463/25; 463/20; 463/42; 463/17

(57) ABSTRACT

In various embodiments a casino has the flexibility to download games from a central controller to the gaming devices on the casino floor. The success of various games is periodically monitored. If a game is successful, as measured by its profitability or by some other success metric, then the game may be downloaded automatically to additional gaming devices. If a game is unsuccessful, then the game may be replaced on a gaming device with a new download. In this way, the types and quantities of different games present on a casino floor may be varied in real time based on their popularity.

### RELATED APPLICATIONS

The present application is a continuation in part of U.S. patent application Ser. No. 09/765,165, filed Jan. 18, 2001, entitled, “METHOD AND APPARATUS FOR SECURING A COMPUTER-BASED GAME OF CHANCE”, which is a continuation of U.S. Pat. No. 6,203,427, filed Jul. 3, 1997, entitled “METHOD AND APPARATUS FOR SECURING A COMPUTER-BASED GAME OF CHANCE”.

### BACKGROUND OF THE INVENTION

An example of an entertainment/gambling device is the “punchboard.” A punchboard consists of a board with a square grid of holes. Each hole contains a small rolled-up piece of paper. The player takes a pin and pushes through the board, pushing a selected piece of paper through the other side. This paper is then unrolled by the player to reveal whether or not he has won a prize. In a typical punchboard game, a player pays a small sum (approximately $1) to make a selection; prizes are determined by the size of the board and the fees, and may run hundreds of dollars. While a player may have faith in a punchboard game played with physical paper and a board, a player may have less faith in an equivalent game played electronically, such as over a network.

### BRIEF DESCRIPTION OF THE DRAWINGS

FIG. 1 is a block diagram showing an overview of the system of the present invention.

FIG. 2 is a block diagram of the central controller of FIG. 1.

FIG. 3 is a block diagram of the user computer of FIG. 1.

FIG. 4 is a block diagram of a trusted third party computer.

FIG. 5 is a schematic representation of the punchboard game area before a game has been played.

FIG. 6 is a schematic representation of the punchboard game area after a game has been played.

FIG. 7a shows in tabular form the fields of the customer database of the central controller.

FIG. 7b shows in tabular form the information in the prize distribution database of the central controller.

FIG. 8 is a flowchart describing initiation of a game according to the preferred embodiments of the present invention.

FIG. 9a shows in tabular form the information in the audit database of the user computer according to the first embodiment of the invention.

FIG. 9b shows in tabular form the information in the game database of the central controller according to the first embodiment of the invention.

FIGS. 10a and 10b are connected flowcharts describing the flow of play between the central controller and user computer according to the first embodiment of the invention.

FIG. 11a shows in tabular form the information in the audit database of the user computer according to the second embodiment of the invention.

FIG. 11b shows in tabular form the information in the game database of the central controller according to the second embodiment of the invention.

FIGS. 12a and 12b are connected flowcharts describing the flow of play between the user computer and the central controller according to the second embodiment of the invention.

FIG. 13a shows in tabular form the information in the audit database of the user computer according to the third embodiment of the invention.

FIG. 13b shows in tabular form the information in the game database of the central controller according to the third embodiment of the invention.

FIGS. 14a, 14b and 14c are connected flowcharts describing the flow of play between the user computer and the central controller according to the third embodiment of the invention.

FIG. 15a shows in tabular form the information in the audit database of the user computer according to the fourth embodiment of the invention.

FIG. 15b shows in tabular form the information in the game database of the central controller according to the fourth embodiment of the invention.

FIG. 16 is a flowchart describing the flow of play between the user computer and the central controller according to the fourth embodiment of the invention.

FIG. 17a shows in tabular form the information in the audit database of the third party according to the fifth embodiment of the invention.

FIG. 17b shows in tabular form the information in the game database of the central controller according to the fifth embodiment of the invention.

FIGS. 18a and 18b are connected flowcharts describing the flow of play between the user computer, the central controller, and the third party computer according to the fifth embodiment of the invention.

FIG. 19 shows in tabular form information in a customer database according to some embodiments of the invention.

FIG. 20 shows a diagram of an exemplary layout of a casino floor according to some embodiments of the invention.

### DETAILED DESCRIPTION OF THE PREFERRED EMBODIMENTS

In accordance with various embodiments of the invention, there is provided a method and apparatus for downloading games, attract modes, promotions, and other software to gaming devices on a network. In some embodiments, the network is a casino-based network that links some or all of the gaming devices, such as slot machines, video poker machines, keno machines, video blackjack machines, and the like, to a central controller. In various embodiments, the central controller predicts which games, attract modes, promotions, and other software are likely to be successful when executed at a gaming device. The central controller may then instruct the gaming device to execute the software that it predicts will be most successful. For example, the central controller may consider the two games of “Pirate's Treasure” and “Evergreen Magic.” The central controller may determine that “Pirate's Treasure” is likely to earn more profits at a particular gaming device than is Evergreen Magic. Accordingly, the central controller may direct the gaming device to feature the game Pirate's Treasure. The central controller may provide the gaming device with an instruction set which may include, for example, software for operating the gaming device in accordance with the rules of Pirate's Treasure. However, if the gaming device already has such an instruction set, then the central controller may direct the gaming device to begin executing the instruction set.

The central controller may establish various success metrics for evaluating the success of an instruction set and for predicting its future success. For example, the central controller may establish success metrics that measure the hourly amounts of profit made by a gaming device when executing an instruction set. The central controller may establish a success metric that measures the average number of minutes per hour that a gaming device was played when it was executing an instruction set. The central controller may establish a success metric that measures the total amount wagered per hour that a gaming device was executing an instruction set. In various embodiments, an instruction set with a high value of a success metric (e.g., with a high amount of profits earned per hour while the instruction set was being executed), may be transmitted to one or more gaming devices, while an instruction set with a low value of a success metric may not be transmitted to any.

The central controller may constantly determine the values of success metrics associated with various instruction sets as they are executed at gaming devices around a casino. Based on the values, the central controller may provide the instruction sets to new gaming devices, or may direct gaming devices currently executing the instruction sets to cease execution. In this way, for example, popular games may be automatically downloaded to more gaming devices on a casino floor, while unpopular games may cease to be featured at gaming devices. A casino may thereby constantly rebalance the games on a casino floor according to their predicted success.

In some embodiments, all gaming devices featuring a particular game at a casino may be occupied. The central controller may accordingly download instruction sets for featuring the game to other gaming devices not currently featuring the game. In this way, the presumably popular game will become available to more players.

In some embodiments, an individual customer's preferred games are known to the central controller. The central controller may determine the location of the customer on a casino floor, and automatically download games preferred by the customer to gaming devices near to the customer. In this way, the customer is likely to easily find games that he likes.

In some embodiments, the success of a particular instruction set may depend on ambient conditions, such as a level of customer traffic, a time of day, or a noise level in the casino. Accordingly, the central controller may adjust which instruction sets are being executed on the casino floor based on ambient conditions. For example, the central controller may direct fifty gaming devices to feature a game in the morning, but may have only ten gaming devices feature the same game in the afternoon. The game may have a history of success in the morning and lack of success in the afternoon.

In accordance with various embodiments of the present invention there is provided a new and improved method and apparatus for facilitating computer-based games of chance on electronic networks such as the Internet. An aspect of the invention comprises the use of encoding techniques, including various encryption schemes, to validate the operation of the games and prevent cheating by either the player or the game provider. Although encryption methods are described, it should be noted that any encoding scheme which prevents the recipient of a message from deciphering its contents will suffice.

In accordance with some embodiments of the invention, a method of generating and verifying the results of a computer-based game of chance is implemented by transmitting to a player computer a plurality of available game selections, each identified by a unique selection identifier. A player selection identifier is received from the player computer, and a winning selection identifier transmitted to the player computer. The player selection identifier and the winning selection identifier are compared to determine if the player has won the game. In accordance with the some embodiments of the invention, verification is made that the winning selection identifier and the player selection identifier were independently generated.

In some embodiments, game operation is managed by a central controller, with players communicating with the controller through player computers connected over an electronic network. In various embodiments of the invention, verification of authenticity is provided in the central controller, the player computer, some combination of both, or with the involvement of a third party.

Games supported include all games of chance that permit a user to select from amongst a plurality of potentially winning selections. Applicable games include, but are not limited to a punchboard having punch locations, a roulette wheel having wheel numbers, a bingo game having user-selected card numbers, and a slot machine having user-selectable outcomes.

Verification is provided through a variety of techniques, including the use of encryption such as key-based encryption, and hash-based encryption. The invention further contemplates the use of a third-party trusted agent to monitor and verify that the player and winning selections were independently generated.

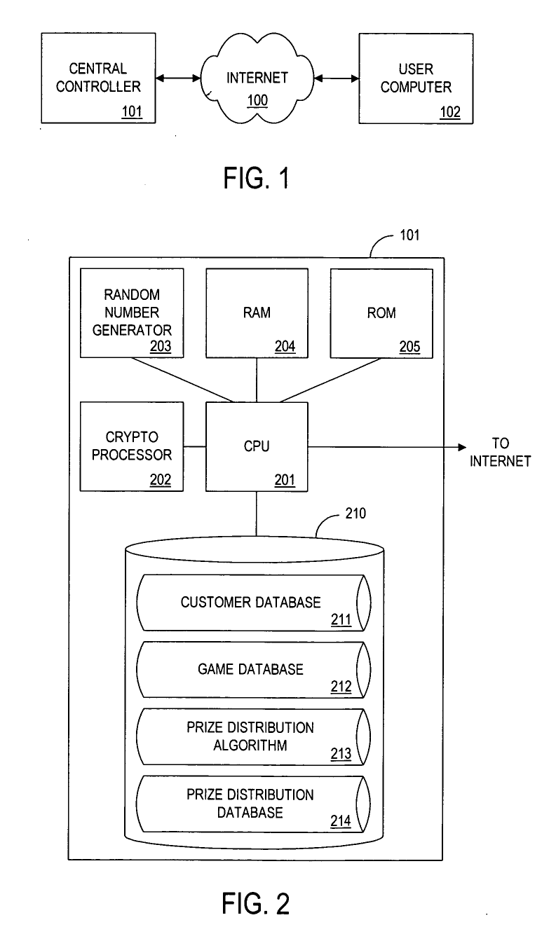

An overview of the system in the preferred embodiments of the present invention is shown in FIG. 1. The central controller 101, operated by the game provider, communicates with the user computer 102 (operated by the game player) over the Internet 100. FIG. 2 is a schematic diagram of the structure of the central controller 101. The central controller includes a CPU 201, connected to a cryptoprocessor 202, a random number generator 203, RAM 204, ROM 205 and a data storage device 210. The CPU 201 connects to the Internet for communication with the player's computer. The data storage device 210 includes a customer database 211, a game database 212, storage for the prize distribution algorithm 213 and a prize distribution database 214. To perform the various functions described in more detail below, the CPU 201 executes a program or programs stored in RAM 204 and/or ROM 205.

Cryptographic processor 202 supports the encoding and decoding of communications with players, as well as the authentication of players. An MC68HC 16 microcontroller, commonly manufactured by Motorola Inc., may be used for cryptographic processor 202. This microcontroller utilizes a 16-bit multiply-and-accumulate instruction in the 16 MHZ configuration and requires less than one second to perform a 512-bit private key operation. Other exemplary commercially available specialized cryptographic processors include VLSI Technology's 33 MHz 6868 or Semaphore Communications' 40 MHZ Roadrunner 284. Alternatively, cryptographic processor 202 may be configured as part of CPU 201.

A conventional random number generating processor may be used for random number generator 203. The HEMT integrated circuit manufactured by Fujitsu, for example, is capable of generating over one billion random numbers per second. Alternatively, random number generator 203 may be incorporated into CPU 201. Data storage device 210 may include hard disk, magnetic, or optical storage units, as well as CD-ROM drives or flash memory.

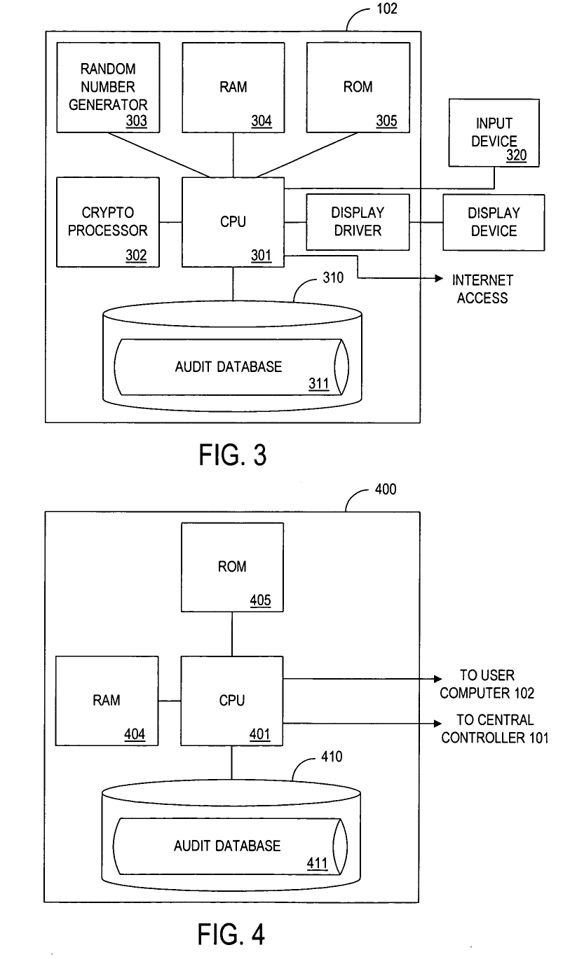

The user computer 102 is shown schematically in FIG. 3. The user computer includes a CPU 301, connected to a cryptoprocessor 302, a random number generator 303, RAM 304, ROM 305 and a data storage device 310. The CPU 301 is also connected to an input device 320 and to the Internet, for communication with the user and the central controller respectively. In addition, the CPU 301 is connected to a display device 330 for displaying a virtual punchboard to the user. The data storage device 310 includes an audit database 311. The CPU 301, cryptoprocessor 302, random number generator 303 and data storage device 310 may have the same features as CPU 201, cryptoprocessor 202, random number generator 203 and data storage device 210 discussed just above.

FIG. 4 is a schematic diagram of a trusted third party computer 400, which is used in an embodiment of the invention discussed in more detail below. This computer includes a CPU 401, RAM 404, ROM 405 and data storage device 410, similar to central controller 101 and user computer 102. The data storage device includes an audit database 411. The CPU 401 is connected for communication with the user computer 102 and the central controller 101.

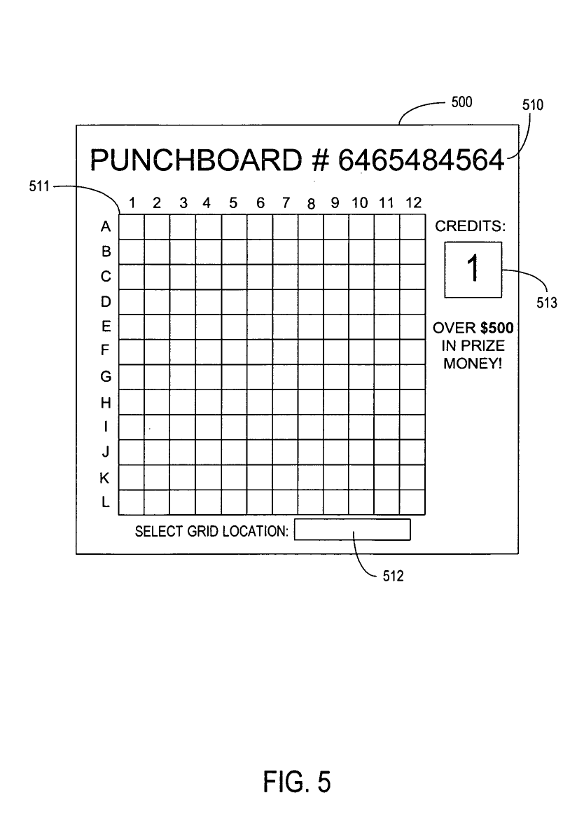

FIG. 5 shows the appearance of a virtual punchboard display 500, displayed to a user on the display device 330, before a game is played. The game is identified by a number 510, and an empty grid 511 is shown (in this case, a 12×12 square). A box 512 appears where the player may enter his selected grid locations. The player's current credits 513 (how much he has paid for the present game, plus his winnings so far) may also be displayed; in the example shown, the player has no winning balance and has just made an electronic payment of $1 to play game # 6465484564.

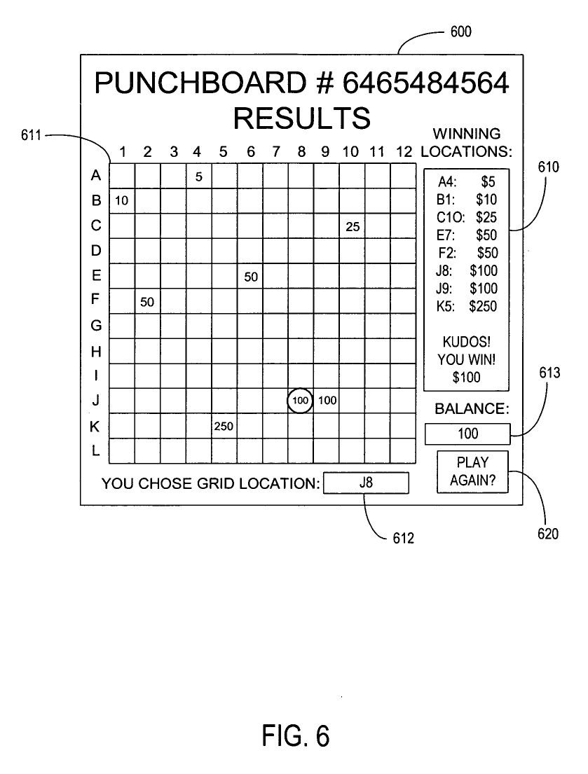

FIG. 6 shows a results display 600, similarly displayed to the user by display device 330, after the game is played. The winning locations are displayed in a table 610 and on the grid 611, with the player's selection circled on the grid and displayed in a box 612. Also displayed is the result of the game (in this case the player is told, “YOU WIN!”) and the balance 613 of the player's winnings. Finally, the display includes a box 620 labeled “PLAY AGAIN?” The CPU 301 may advantageously execute interactive display software (stored in RAM 304 or ROM 305) which enables “click boxes” and the like. In that case, the player would click on the “PLAY AGAIN?” box to order a new game.

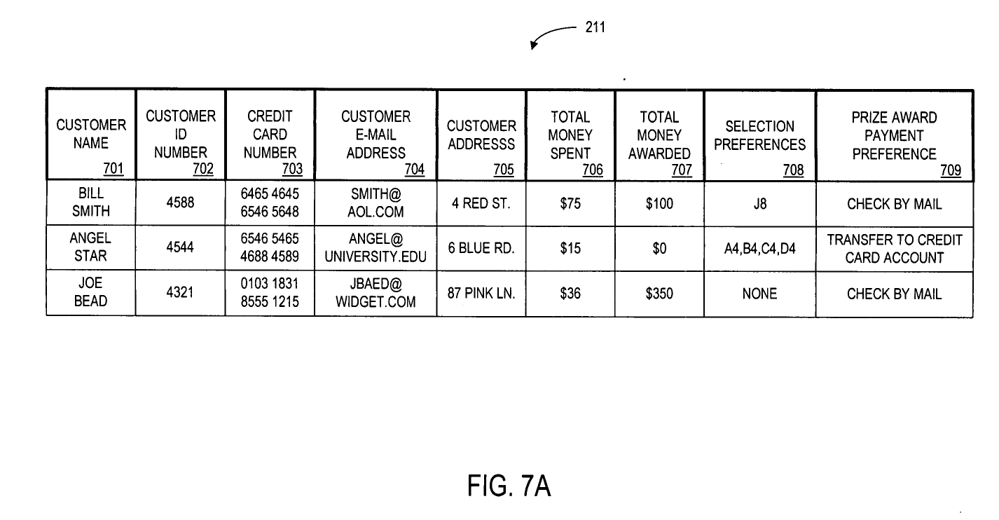

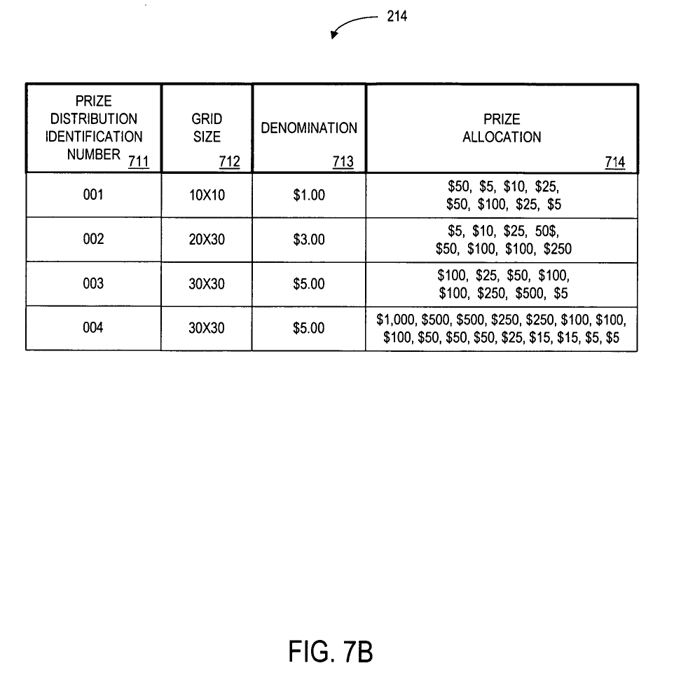

FIG. 7a shows the fields of the customer database 211 maintained by the central controller 101. Each customer is identified by name 701 and is assigned an ID number 702. Each customer entry in the database also includes a credit card number 703, the customer's e-mail address 704 and postal mailing address 705, the total amount the customer has spent 706, and the customer's total winnings to that point 707. The database stores the grid selection preferences 708 for each customer (so that a player who regularly plays the same location on the grid need not enter that location in every game), and the customer's preferred method 709 of receiving his winnings.

The fields of the prize distribution database 214, maintained by the central controller 101, are shown in FIG. 7b. Each prize distribution is assigned an identification number 711. Each entry in the database includes the size 712 of the grid, the denomination of the game 713 (that is, the cost to the customer for one play) and the number and amount of prizes 714 to be awarded. Generally, a larger grid has more prizes associated therewith, and a grid with larger prizes has a larger associated denomination.

To create a new game, the central controller 101 employs a prize distribution algorithm 213 having the following steps: The central controller 101 retrieves the prize structure 714 and grid size 712 from the prize distribution database 214 by searching for the prize distribution ID number 711. The CPU 201 instructs the random number generator 203 to produce enough random numbers to cover the number of grid locations for the game. Each random number is appended to a grid location. The format might be (x,y,r), where “x” is the x-coordinate of the grid location, “y” is the y-coordinate of the grid location, and “r” is the assigned random number. The random numbers are then ranked numerically. Prizes are then appended to each grid location. The format might be (x,y,r,p), with “p” the prize value (which may be zero) assigned to the grid location (x,y). The game is then assigned an ID number. The winning grid locations for the game, and the prizes associated with those locations, are then stored in the game database 212, detailed embodiments of which are described below. Those skilled in the art will appreciate that there are many possible algorithms by which the prices may be randomly assigned. The above algorithm is merely illustrative

First Embodiment (User Computer Encryption)

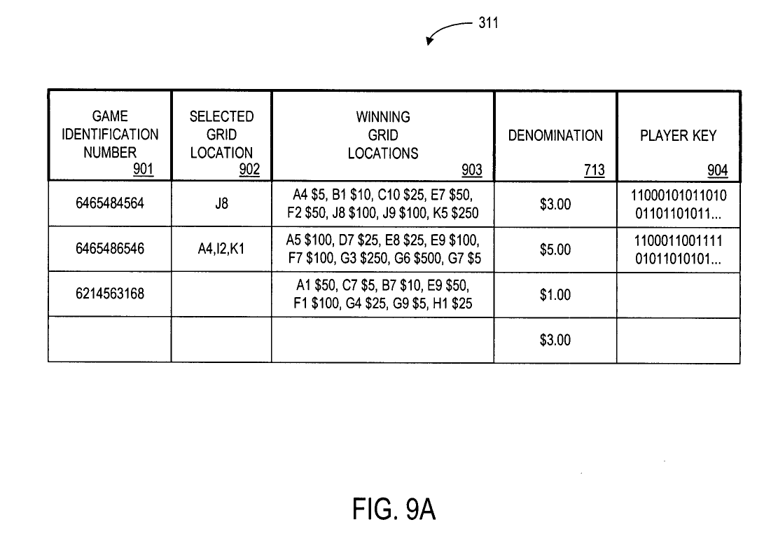

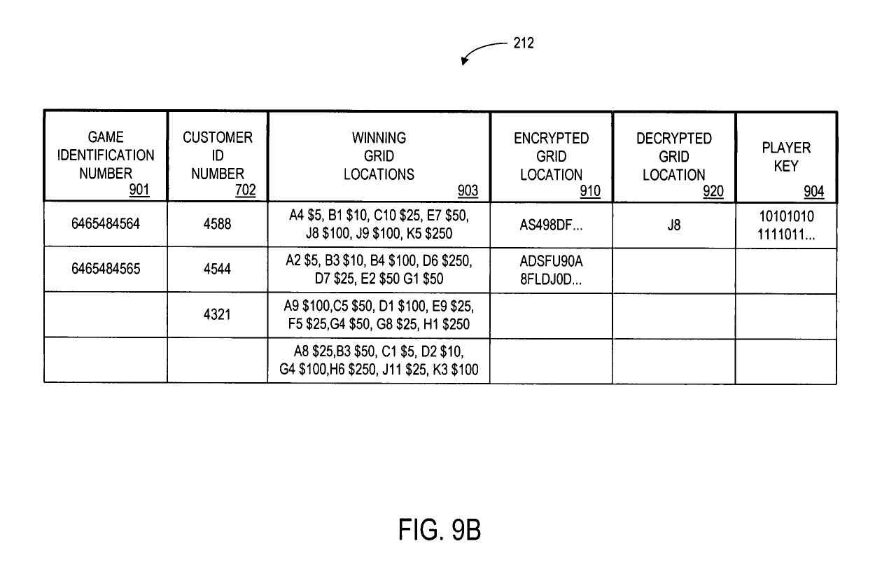

In the first embodiment of the invention, the fields of the audit database 311 (stored in the user computer 102) are as shown in FIG. 9a. Each record in the audit database 311 corresponds to one game played by the user, and is filled in as the game progresses (as described in detail below). A record includes an identification number 901 for the game, the grid location or locations 902 selected by the player, the winning grid locations 903, the game denomination 713, and a random key 904 which the player uses to encrypt his grid location selections.

In this embodiment, the fields of the game database 212 (stored in the central controller 101) are as shown in FIG. 9b. Each record in the game database corresponds to one game (having an ID number 901) played by one player (having an ID number 702). Each record includes the winning grid locations 903, the player's selected and encrypted grid location 910, the corresponding decrypted grid location 920, and the player key 904.

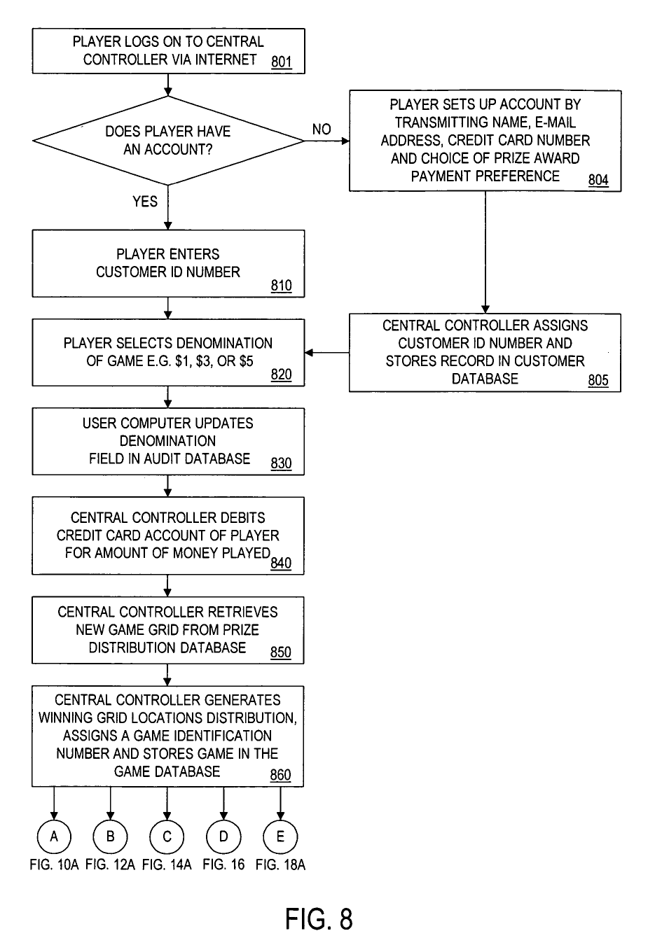

A game conducted according to the first embodiment of the invention begins with the steps shown in the flowchart of FIG. 8. Initially, the player (using his computer 102) logs on to the central controller 101 via the Internet 100 (step 801). If the player does not yet have an account (that is, an entry in the customer database 211), an account is opened at this time; the player provides the necessary information (step 804), and the central controller 101 assigns him an ID number and stores the new record in the customer database 211 (step 805). If the player already has an account, he enters his customer ID number 702 (step 810).

The player then selects the amount of money he wishes to play—that is, the denomination of the game; for example, $1, $3, or $5 (step 820). The user computer 102 updates the denomination field 713 in the audit database 311 (step 830). The central controller 101 debits the credit card account of the player for the amount of money played (step 840). The central controller 101 retrieves a new game grid from the prize distribution database 214 (step 850). Using the prize distribution algorithm 213 described above, the central controller 101 generates the winning grid locations 903, assigns the game identification number 901 and stores the game in the game database 212 (step 860).

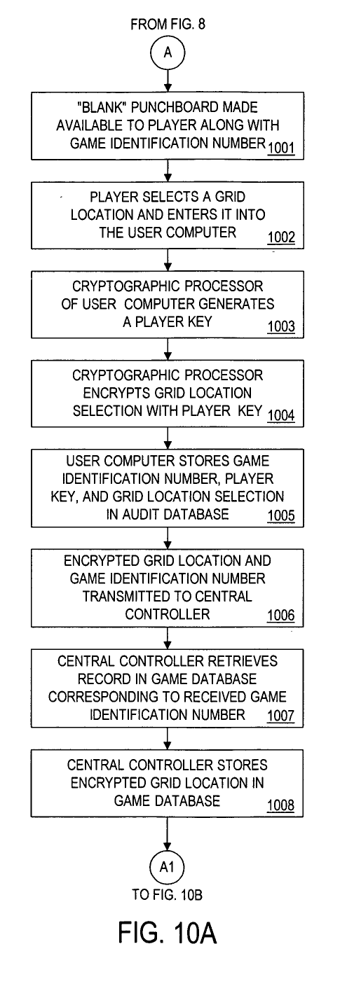

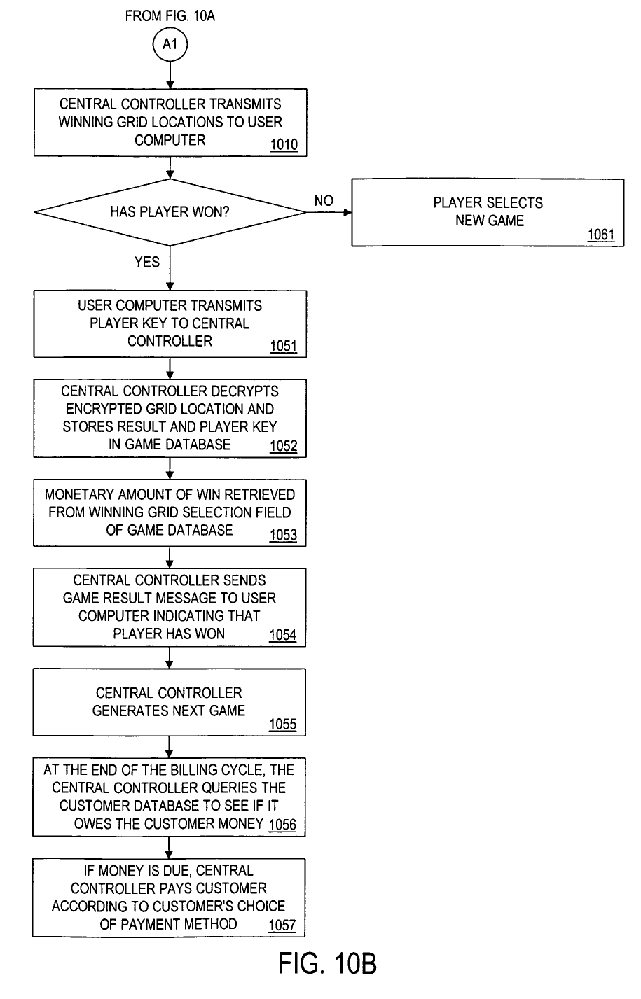

In this embodiment, the game continues with the steps shown in the flowcharts of FIGS. 10a and 10b. In step 1001 of FIG. 10a, a “blank” punchboard 500 including the game identification number 510 is made available to the player. The player selects a grid location 902 and enters it into the user computer 102 using input device 320 (step 1002). The cryptographic processor 302 of the user computer 102 generates a player key 904, preferably based on a random number generated by random number generator 303 (step 1003). The cryptographic processor 302 encrypts the grid location selection 902 with the player key (step 1004). The user computer 102 stores the game identification number, player key, and grid location selection in the audit database 311 (step 1005).

In step 1006, the encrypted grid location and game identification number are transmitted to the central controller 101. The central controller then retrieves the record in the game database 212 corresponding to the game identification number received from the user computer 102 (step 1007). The central controller 101 stores the encrypted grid location 910 in the game database 212 (step 1008).

At this point, the central controller 101 has the player's grid location selection, but only in an encrypted form. The central controller 101 then transmits the winning grid locations 903 to the user computer 102 (step 1010 of FIG. 10b).

If the player has not won, he may proceed to select a new game (step 1061). If the player has won, the user computer 102 transmits the player key 904 and game identification number to the central controller 101 (step 1051). The central controller decrypts the encrypted grid location 910, and stores the decryption result 920 (the player's selected, winning grid location) and player key 904 in the game database 212 (step 1052).

The amount of money won by the player is retrieved from winning grid location field 903 of the game database 212 (step 1053). The central controller 101 then sends the game result message 600 to the user computer 102, indicating that the player has won (step 1054). The central controller then proceeds to generate the next game (step 1055).

At the end of the billing cycle, the central controller 101 queries the customer database 211 to see if the customer is owed money (step 1056). If money is due the customer, the central controller 101 initiates a payment to the customer according to the customer's preferred payment method 709 (step 1057).

It should be noted that a key element of this embodiment is that the user sends his grid location selection in encrypted form (thus unreadable by the central controller 101) to the central controller before receiving the winning grid locations. The player is thereby assured that the game provider cannot change the winning locations based upon knowledge of his selection. On the other hand, the central controller holds the player's encrypted selection before the player is given the winning locations, and the player must provide the key to decrypt his selection before the central controller awards him a prize. The encryption of the player's selection thus assures both parties that the game has been fairly conducted, and that the two numbers were independently generated.

A transmission between the central controller and the player may include a digital signature to provide further assurance of the authenticity of the transmission, and to prevent repudiation by the sender. The uses and advantages of digital signatures are discussed generally in Schneier, “Applied Cryptography” (2d ed. 1996), chapter 2.

The above embodiment is also applicable to a game such as roulette. Instead of encoding his grid location selection, the player encrypts his number selection (representing any of the 38 wheel slots). The central controller then transmits the result of the wheel spin to the player.

The game of bingo could be simulated as follows. The player selects a board and then encrypts his selection before sending it to the central controller. The central controller then sends out each bingo number until one of the players claims a win. The winning player sends his key to the central controller so that his selection can be verified.

To simulate a slot machine, the player simply selects one of the possible reel combinations of the slot machine. In a slot machine with three reels and 20 stops per reel, there are 8,000 (20×20×20) possible outcomes, so the player could select one of these at random, encrypting the selection and sending it to the central controller. The central controller then distributes the prizes among the possible outcomes and sends the complete set of outcomes to the player so that he can determine whether or not he has won.

Second Embodiment (One-Way Hash)

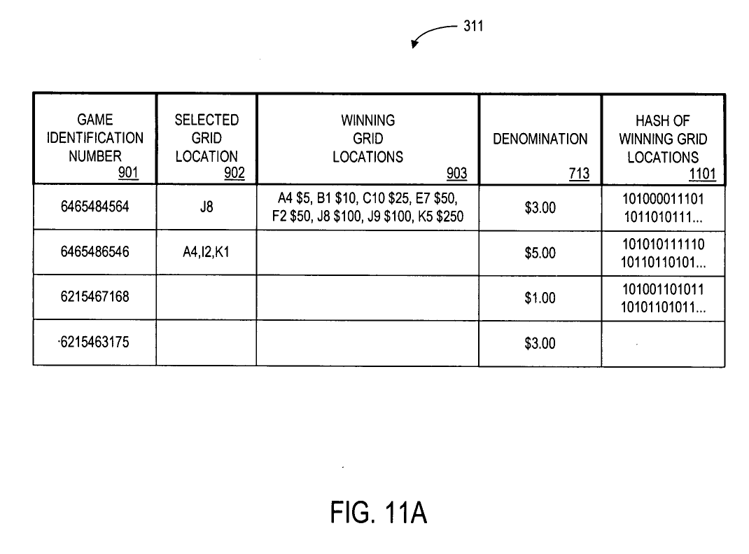

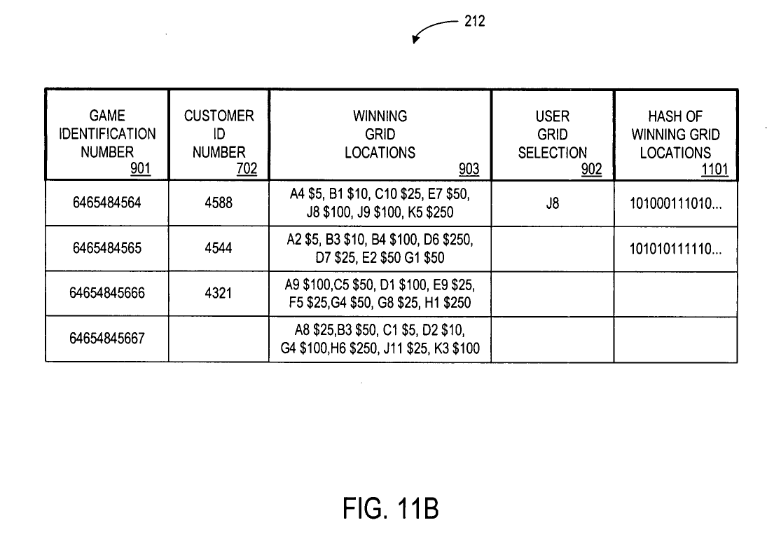

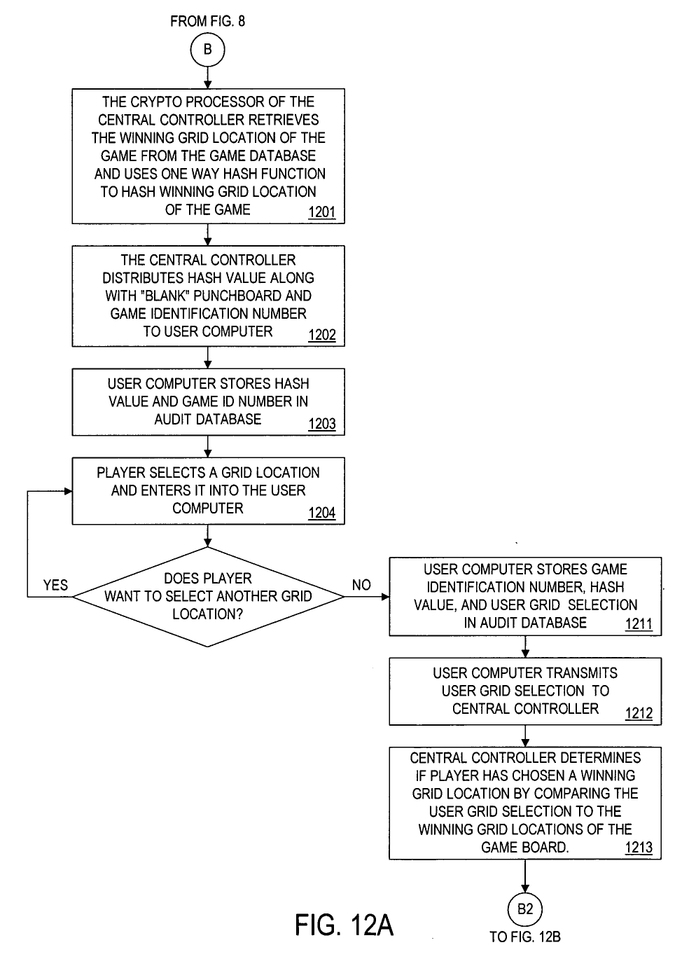

In the second embodiment of the invention, the audit database 311 in the user computer 102 has a structure as shown in FIG. 11a. As in the first embodiment, each record in the audit database corresponds to one game. A record includes the game identification number 901, selected grid location or locations 902, winning grid locations 903 and the game denomination 713, similar to the record shown in FIG. 9a. In this embodiment, the record also includes the hash value 1101 of the winning grid locations 903.

The structure of the game database 212 in this embodiment is shown in FIG. 11b. Each entry in the game database has a game identification number 901, a customer identification number 702 and the winning grid locations 903, as in the first embodiment. The entry also has the user-selected grid location 902 and the hash value 1101 of the winning grid locations 903.

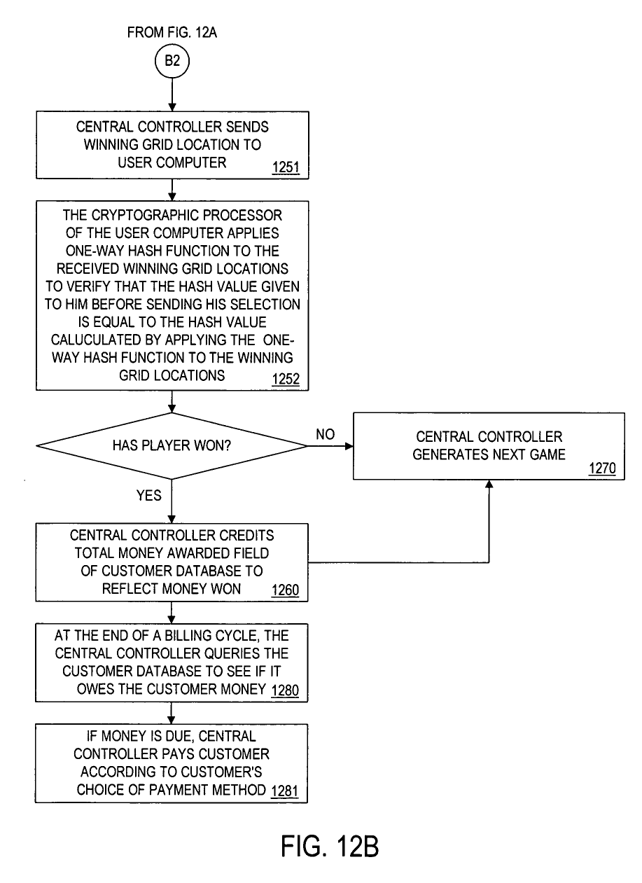

A game conducted according to the second embodiment of the invention begins with the steps shown in the flowchart of FIG. 8 as already described above, and continues with the steps shown in the flowcharts of FIGS. 12a and 12b. In step 1201 of FIG. 12a, the cryptoprocessor 202 of the central controller 101 retrieves the winning grid locations 903 of the game from the game database 212, and uses a one-way hash function to hash the winning grid locations 903, thereby generating the hash value 1101. The hash value 1101 represents a one-way transformation of the winning grid locations 903.

An important feature of the one-way hash function is that it is computationally simple (given the hash function) to generate the hash value, but computationally unfeasible to recreate the winning grid locations from the hash value alone. The hash value 1101 thus serves as a unique identifier for the winning grid locations 903, without the winning grid locations themselves being revealed. Further details on one-way hash functions are given in Schneier, “Applied Cryptography” (2d ed. 1996), chapter 18.

The central controller 101 distributes the hash value 1101 to the user computer 102, along with a “blank” punchboard 500 with game identification number 510 (step 1202). The user computer 102 stores the hash value and game ID number in the audit database 311 (step 1203). In step 1204, the player selects a grid location and enters it into the user computer 102; the player may make additional grid location selections. Once the player has made all of his selections, the user computer 102 stores the game identification number 901, the selected grid locations 902 and the hash value 1101 in the audit database 311 (step 1211). The user computer 102 transmits the selected grid locations 902 to the central controller 101 along with the game ID number (step 1212). It should be noted that at this point the central controller 101 has the player's selections, but has already provided the player with a representation of the winning grid locations in the form of the hash value 1101. In step 1213, the central controller 101 determines whether the player has chosen a winning grid location by comparing the selected locations 902 with the winning grid locations 903 for that game.

Referring now to FIG. 12b, the central controller 101 sends the winning grid locations 903 to the user computer 102 (step 1251). In step 1252, the user computer 102 verifies the fairness of the game. Specifically, the cryptographic processor 302 of the user computer 102 applies the one-way hash function to the received winning grid locations to verify that the hash value 1101 given to him before sending his selection is equal to the new hash value calculated by applying the one-way hash function to the winning grid locations.

If the player has not won, the central controller 101 proceeds to generate the next game (step 1270). If the player has won, the central controller 101 updates the total money awarded 707 in the customer database 211 to reflect the amount the player has just won (step 1260), and then generates the next game. In addition, at the end of a billing cycle, the central controller 101 queries the customer database 211 to see if the customer is owed money (step 1280). If money is due the player, the central controller 101 initiates a payment to the customer according to customer's payment method preference 709 (step 1281).

It should be noted that in this embodiment the punchboard cannot be reused; it must be replaced with a fresh punchboard after each player selection. If the punchboard were not replaced, the player could continue to select grid locations after receiving the winning grid locations 903 (see step 1251). The player could, however, make more than one selection during a game session (see step 1204), as long as each selection was received by the central controller 101 before the winning locations were transmitted to the player.

With minor modifications, this embodiment of the invention can accommodate any number of players. By delaying the transmission of the winning grid locations until after all grid location selections have been received, any number of players can be accommodated with one punchboard. Alternatively, games could be conducted at great speed, preventing players from cheating by sharing winning locations. For example, two players might make selections on the same punchboard nearly simultaneously. The first player sends his grid location selection and then receives the winning grid locations. A fraction of a second later the second player sends his grid location selection.

If the first player can communicate with the second player he can inform the second player of the winning grid locations, ensuring a win for the second player. If the time difference between the two plays is small enough, however, the first player will not have enough time to communicate the winning locations.

Third Embodiment (Hash Tree)

The third embodiment of the invention uses hash trees to accommodate multiple players in a single punchboard game. Details of hash tree techniques are well known in the art and for reference purposes are discussed in Merkle (U.S. Pat. No. 4,309,569).

In this embodiment, each grid location is represented by (x,y,p,h_{xy′}), where x and y are the coordinates, p is the prize associated with that location, h_{xy} is the hash value of that location, and h_{xy′} is an aggregate hash value for all the other locations. Furthermore, a hash value, h, is calculated for the entire grid (including all locations) using hash function H. This function has the property H(h)=H(h_{xy},h_{xy′}) That is, the hash value for the entire grid is equal to the hash value of one location combined with the locations's h_{xy′} value. For additional security, a random number may be attached to each grid location to provide greater variation in the resulting hash values.

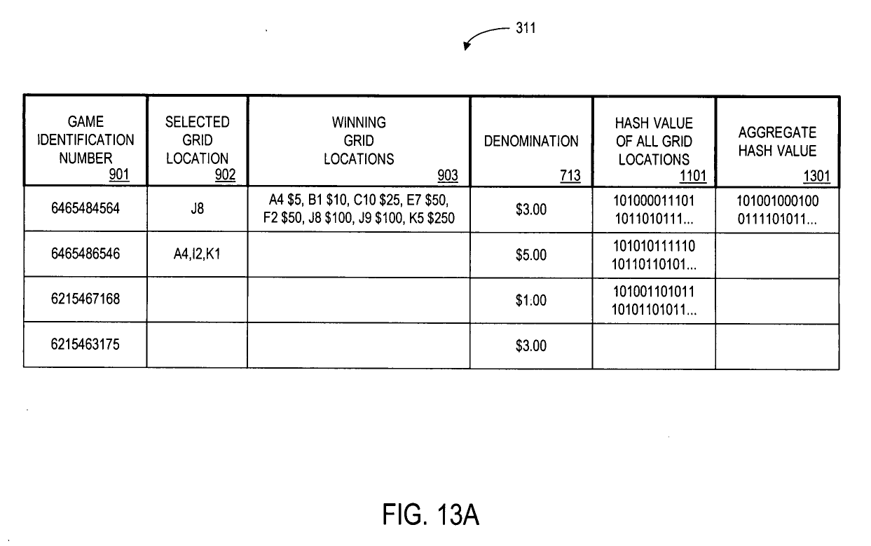

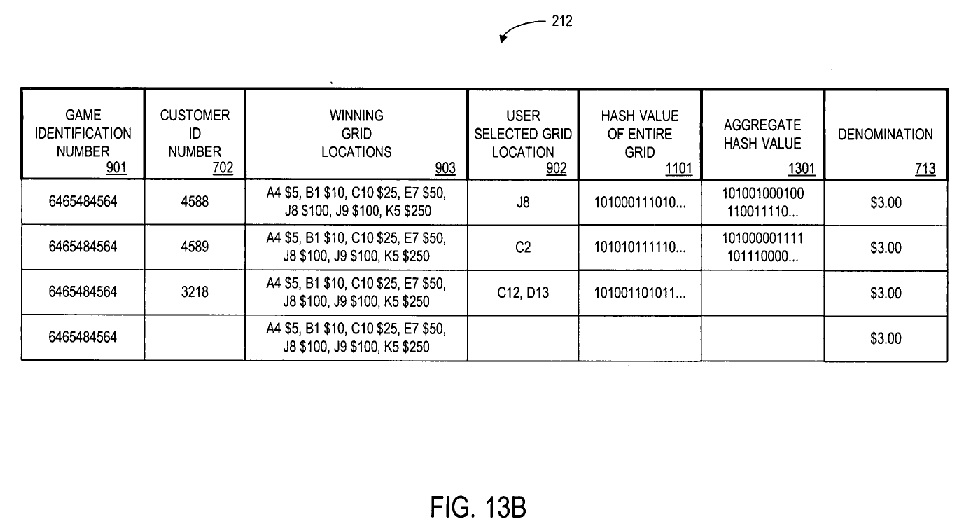

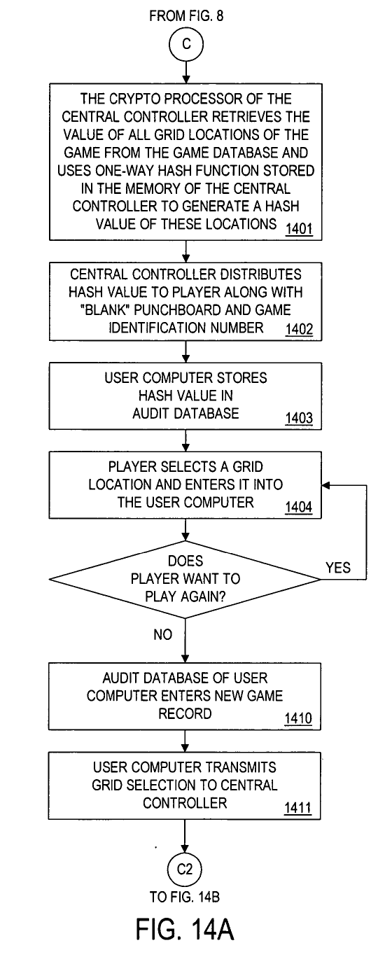

In this embodiment of the invention, the audit database 311 in the user computer 102 has a structure as shown in FIG. 13a. As in the previous embodiments, each record in the audit database corresponds to one game. A record includes the game identification number 901, selected grid location or locations 902, winning grid locations 903 and the game denomination 713, similar to the records shown in FIGS. 9a and 1a. In this embodiment, the record also includes the hash value 1101 for all grid locations (both winning and losing), and an aggregate hash value 1301, representing the hash value of the aggregate of all the grid locations not selected by the player (i.e. the h_{xy′} values of all the grid locations selected by the player).

The structure of the game database 212 in this embodiment is shown in FIG. 13b. Each entry in the game database has a game identification number 901, a customer identification number 702 and the winning grid locations 903, as in the previous embodiments. The entry also has the user-selected grid location 902, the denomination 713 of the game, the hash value 1101 for all grid locations, and the aggregate hash value 1301.

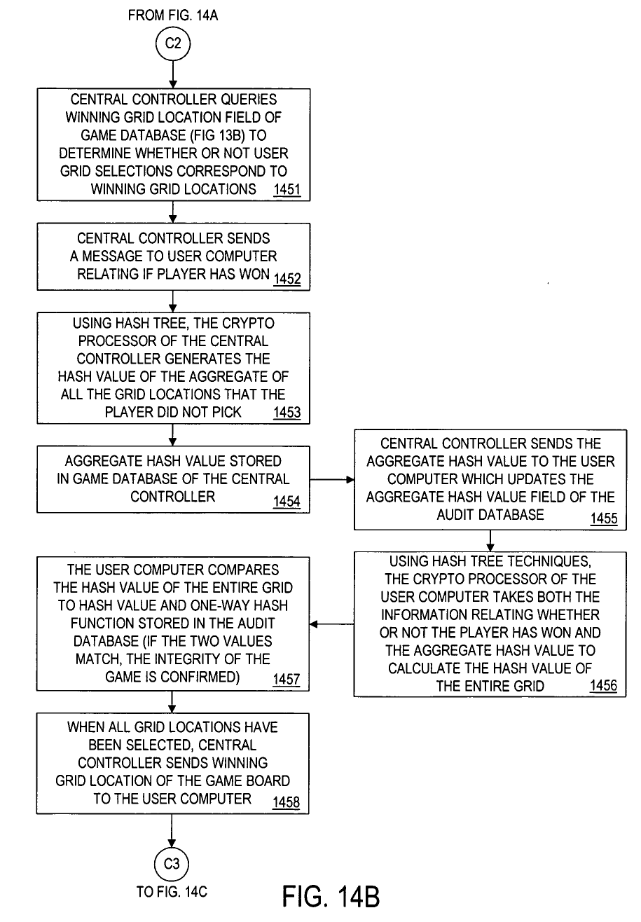

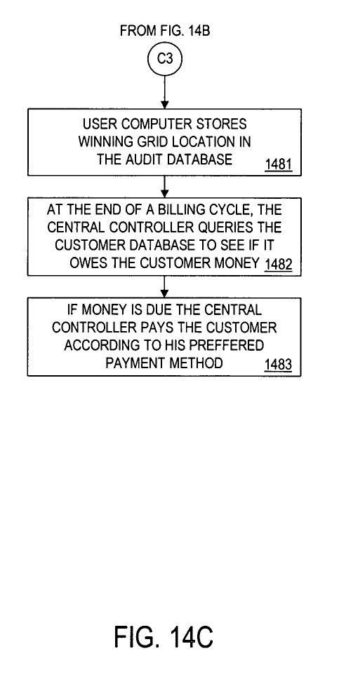

A game conducted according to the third embodiment of the invention begins with the steps shown in the flowchart of FIG. 8 as already described above, and continues with the steps shown in the flowcharts of FIGS. 14a, 14b and 14c.

In step 1401, the cryptoprocessor 202 of the central controller 101 retrieves the value of all grid locations of the game from the game database 212, and uses one-way hash function H stored in the memory (RAM 204 or ROM 205) of the central controller to hash these grid locations, thereby generating h, the hash value 1101 (i.e. the hash value of all grid locations). The central controller 101 then (step 1402) distributes the hash value 1101 to the user computer 102, along with a “blank” punchboard 500 including the game identification number 510. The user computer 102 stores the hash value 1101 in the audit database 311 (step 1403). The player selects a grid location 902 and enters it into the user computer 102, using the input device 320 (step 1404). The player may enter additional selections if he so desires. After the player has made all of the selections for that game, a new record is entered in the audit database 311 of the user computer 102, reflecting the ID number for the game and the player's selected grid locations (step 1410). The user computer 102 then transmits the player's grid selections 902 and game ID number to the central controller 101 along with the game ID number (step 1411).

The central controller then (step 1451) queries the game database 212 to obtain the winning grid locations 903, to determine whether or not the player's grid selections correspond to the winning grid locations. The central controller 101 sends a message to the user computer 102 relating whether the player has won (step 1452).

The integrity of the game is verified in steps 1453 through 1457. Using the hash tree algorithm, the cryptoprocessor 202 of the central controller 101 generates (step 1453) an aggregate hash value 1301; this value is the hash value of the aggregate of all the grid locations that the player did not pick (i.e. h_{xy′}). The aggregate hash value 1301 is stored in the game database 212 of the central controller (step 1454). In step 1455, the central controller 101 sends the aggregate hash value 1301 to the user computer 102, which updates the aggregate hash value field of the audit database 311.

Using hash tree techniques, the cryptoprocessor 302 of the user computer 102 takes both the information relating to the prize value corresponding to the player's selection (i.e. h_{xy}) and the aggregate hash value 1301 to calculate a hash value for the entire grid (step 1456). In step 1457, the user computer 102 uses hash tree techniques to compare this hash value for the entire grid to the hash value 1101 stored in the audit database 311. If the two values match, the integrity of the game is confirmed.

At this point, the player does not know the location of any winning locations on the grid, and therefore cannot help any other player to win. The winning grid locations are not revealed until all players have made all of their selections.

When all grid locations have been selected by all the players, the central controller 101 sends the winning grid locations to the user computer 102 (step 1458). The user computer stores the winning grid locations in the audit database 311 (step 1481). At the end of a billing cycle, the central controller 101 queries the customer database 211 to see if the customer is owed money (step 1482). If money is due the customer, the central controller 101 initiates a payment to the customer according to the customer's preferred payment method 709 (step 1483).

Fourth Embodiment (Central Controller Encryption)

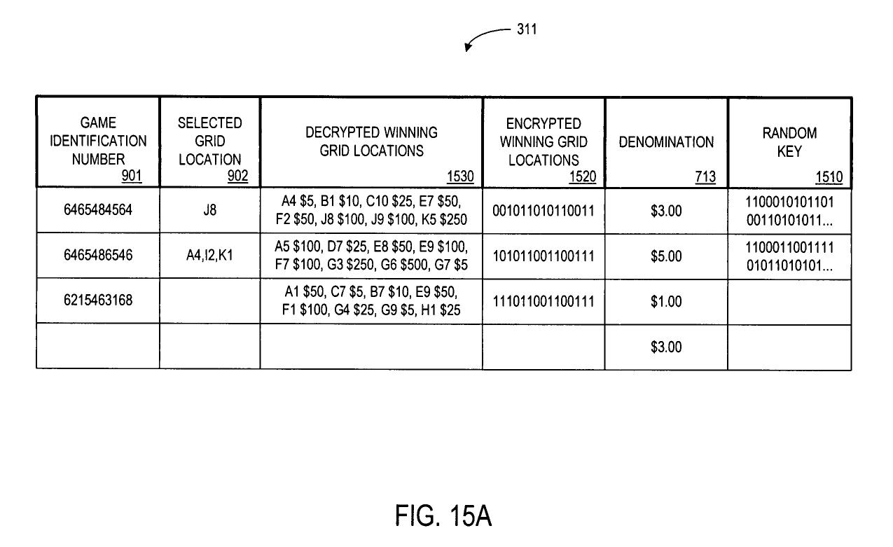

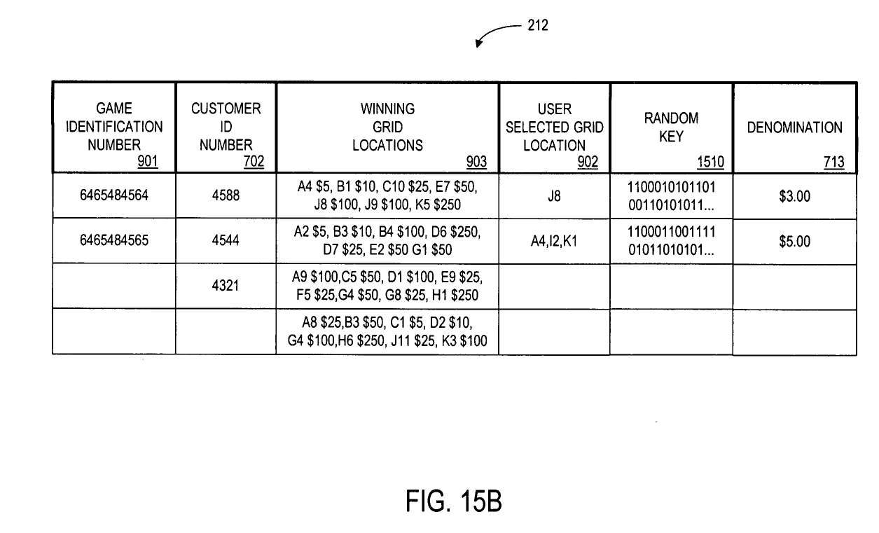

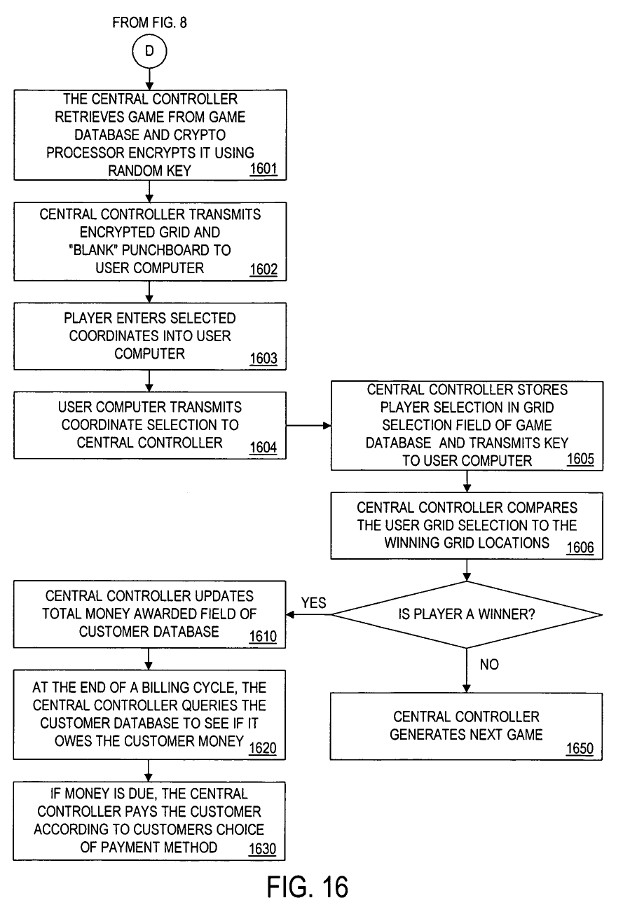

In the fourth embodiment of the invention, the audit database 311 in the user computer 102 has a structure as shown in FIG. 15a. As in the previous embodiments, each record in the audit database corresponds to one game. A record includes the game identification number 901, selected grid location or locations 902, and the game denomination 713. In this embodiment, the record also includes a random key 1510, and encrypted and decrypted versions (1520 and 1530 respectively) of the winning grid locations.

The structure of the game database 212 in this embodiment is shown in FIG. 15b. Each entry in the game database has a game identification number 901, a customer identification number 702 and the winning grid locations 903, as in the previous embodiments. The entry also has the user-selected grid location 902, the game denomination 713 and the random key 1510.

A game conducted according to the fourth embodiment of the invention begins with the steps shown in the flowchart of FIG. 8 as already described above, and continues with the steps shown in the flowchart of FIG. 16.

In step 1601, the central controller 101 retrieves the winning grid locations 903 for a game from the game database 212; the cryptoprocessor 202 encrypts these locations using the random key 1510. The central controller 101 then transmits the encrypted grid locations to the user computer 102 along with the “blank” electronic game board (step 1602). The player enters his grid location selections into the user computer 102, using the input device 320 (step 1603). The user computer 102 transmits the player's grid location selection to the central controller along with the game ID number (step 1604). In step 1605, the central controller stores the player's selections in the selected grid locations field 902 of the game database 212, and then transmits the key 1510 to the user computer 102. The central controller 101 then (step 1606) compares the user selected grid locations 902 with the winning grid locations 903.

If the player is not a winner, the central controller proceeds to generate the next game (step 1650). If the player is a winner, the central controller 101 updates the total money awarded 707 in the customer database 211 to reflect the amount the player has just won (step 1610). In addition, at the end of a billing cycle, the central controller 101 queries the customer database 211 to see if the customer is owed money (step 1620). If money is due the player, the central controller 101 initiates a payment to the customer according to customer's payment method preference 709 (step 1630).

It should be noted that a key element of this embodiment is that the central controller 101 sends the winning grid locations to the user computer 102 (though encrypted and thus unreadable by the user computer) before receiving the user's grid location selection. The player is thereby assured that the game provider cannot change the winning locations based upon knowledge of his selection. On the other hand, the central controller holds the player's selection before the player is provided with the key to decrypt the winning locations. The encryption of the winning locations thus assures both parties that the game has been fairly conducted.

This embodiment is particularly applicable to games such as blackjack, in which the central controller could randomly arrange an electronic deck of cards, encrypt them, and transmit them to the player. The player then sends card selections and play decisions to the central controller.

Fifth Embodiment (Trusted Third Party)

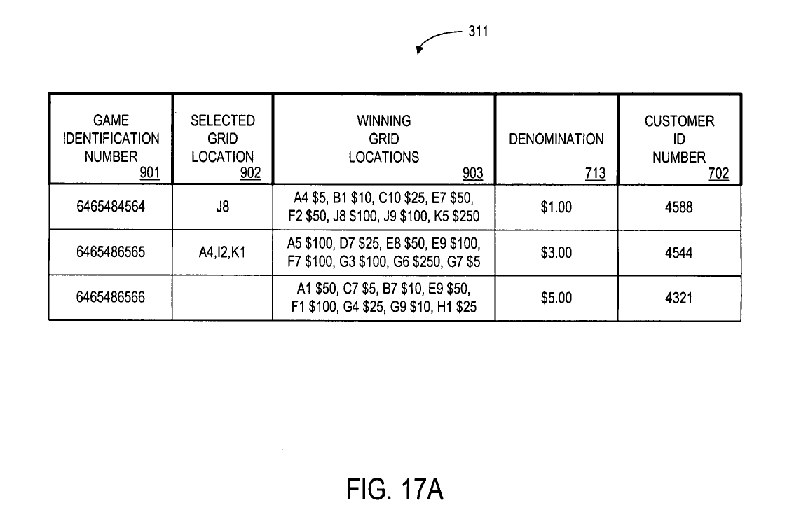

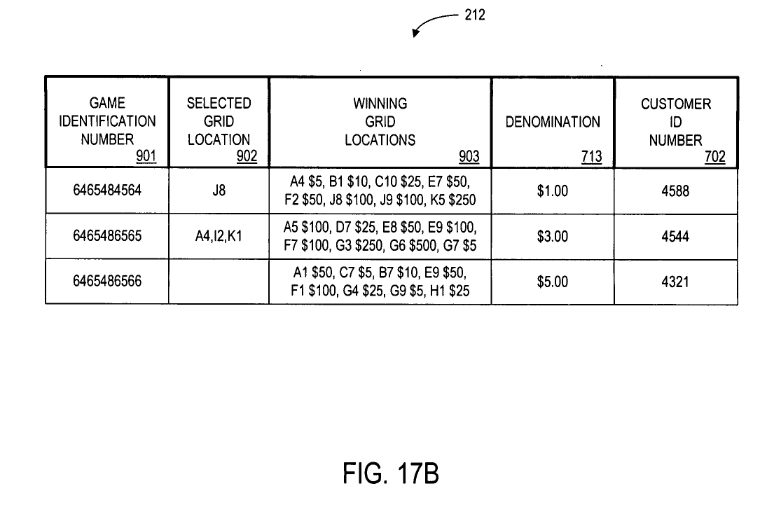

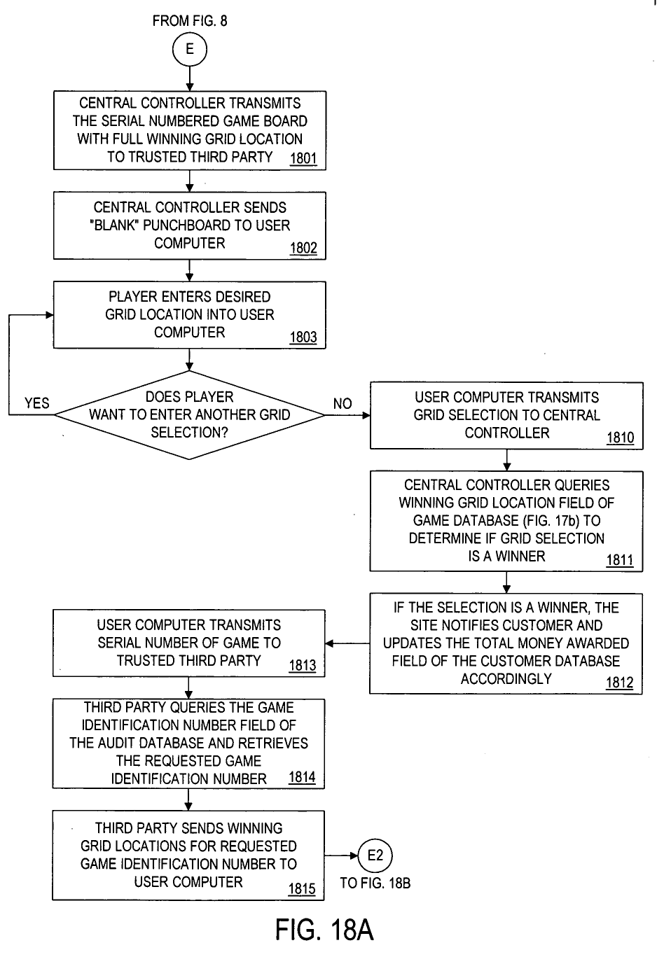

In the fifth embodiment of the invention, a trusted third party computer 400 is used to assure the integrity of the game. The audit database 311 in the user computer 102, the audit database 411 in the trusted third party computer 400 (both shown in FIG. 17a) and the game database 212 in the central controller 212 (shown in FIG. 17b) have the same structure. Each record in these databases corresponds to one game. A record includes the game identification number 901, selected grid location or locations 902, the winning grid locations 903, the game denomination 713 and the customer identification number 702.

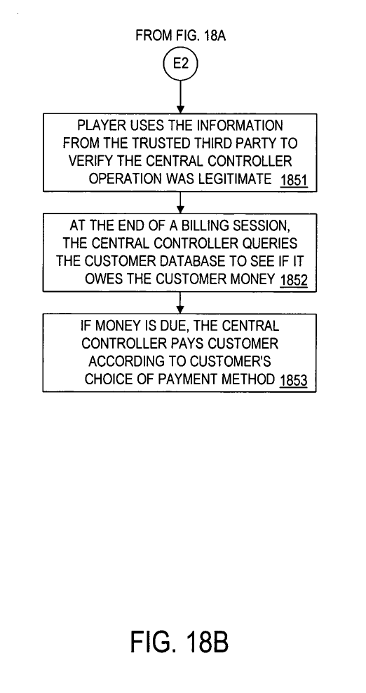

A game conducted according to the fifth embodiment of the invention begins with the steps shown in the flowchart of FIG. 8 as already described above, and continues with the steps shown in the flowcharts of FIGS. 18a and 18b. In step 1801, the central controller 101 transmits the game identification number 901 and the winning grid locations 903 to the trusted third party 400. The central controller 101 then sends a “blank” punchboard 500 to the user computer 102 (step 1802). The player selects a grid location 902 and enters it into the user computer 102, using the input device 320 (step 1803). The player may enter additional selections if he so desires. After the player has made all of the selections for that game, the user computer 102 transmits the player's grid selections 902 to the central controller 101 (step 1810). The central controller queries the winning grid location field 903 of the game database 212 to determine if the player's grid selection is a winner (step 1811). If the selection is a winner (step 1812), the controller notifies the player and updates the total money awarded field 707 of the customer database 211 accordingly.

The user computer 102 then transmits the game identification number to the trusted third party 400 (step 1813). The CPU 401 of the third party computer 400 queries the game identification number field 901 of the audit database 411 and retrieves the requested game identification number (step 1814). The third party computer 400 then sends the winning grid locations corresponding to the requested game identification number to the user computer 102 (step 1815).

In step 1851, the player uses the information from the trusted third party 400 to verify that the game provided by the central controller 101 was legitimate. In this embodiment, the use of the trusted third party makes encryption of player selected grid locations and winning grid locations unnecessary.

At the end of a billing cycle, the central controller 101 queries the customer database 211 to see if the customer is owed money (step 1852). If money is due the player, the central controller 101 initiates a payment to the customer according to customer's payment method preference 709 (step 1853).

Many variations of the embodiments discussed above are possible. For example, the central controller can track the amount of play engaged in by individual users for marketing purposes. In particular, special advertisements could be transmitted over the Internet targeted to high volume players. The central controller may offer demonstration games for new users so that they learn how to play. The game may be configured as a “pulltab” game, rather than punchboard. A user may be offered discounts on subsequent game, to provide him with an incentive to play again.

Although the above embodiments have been described with reference to a remote player making payments by credit card, a number of payment methods are possible. For example, the player may maintain an account with the game provider, or make payments with digital cash. Furthermore, rather than interact remotely with the central controller, the player may make his payment to a live cashier, who then enters the amount of credit into the central controller using an input device.

In addition, although the above embodiments have been described with reference to communication over the Internet, it will be appreciated that the practice of our invention is not limited to Internet communications, but is applicable to a variety of possible modes of communication between the game provider and the player. Commercial online services such as CompuServe and America Online could implememt the systems and methods of the present invention.

Each of the above-described embodiments of the virtual punchboard is generally applicable to a game in which a player predicts a random outcome. One skilled in the art will appreciate how the various aspects of the virtual punchboard may be implemented in other games of chance (roulette, bingo, slot machines, blackjack, craps, lottery, etc.).

Various embodiments described herein have included communication between a central controller and a user computer. This communication may occur via an electronic network, such as the Internet, for example. A player at a user computer may receive game information from the central controller, may communicate game information to the central controller, and may thereby arrive at a game result, such as a win or loss for the player.

Various embodiments include a central controller that is in communication with one or more gaming devices, such as slot machines, video poker machines, video blackjack machines, video keno machines, and so on. The central controller may communicate with the gaming devices via an electronic network, such as a local area network, or wireless network.

Applicants have recognized that gaming devices are constantly being developed with improved capabilities, such as better graphics, faster processing speeds, clearer audio, and so on. In fact, gaming devices may possess all of the flexibility of a modern personal computer, with the inherent ability to run a wide range of software. For example, Bally Gaming Systems' EVO VIDEO platform for gaming devices is powered by a Microsoft® Windows XP Embedded operating system and features an Intel Pentium® series processor.

Applicants have recognized that the power and flexibility of modern gaming devices allows a given gaming device to feature a variety of different games. For example, a gaming device may allow a player to play a first game at a first time, and a second game at a second time.

Applicants have further recognized that a gaming device may feature a variety of “attract modes”, such as sounds or examples of game play that are broadcast in order to attract passing players to the gaming device. A single gaming device may include a first attract mode that is designed to encourage play of a first game, and a second attract mode that is designed to encourage play of a second game. For example, a gaming device might allow play of both video poker and of a five-reel slot game. In a first attract mode, the gaming device might show an example of game play in which a royal flush is achieved. The first attract mode might serve to attract players to play video poker. In a second attract mode, the gaming device might show an example of game play in which five “elephant” symbols are aligned in the five-reel slot game, resulting in the win of a jackpot. The second attract mode might serve to attract players to play the five-reel slot game.

Applicants have further recognized that a gaming device may periodically receive instructions from the central controller. The central controller may, for example, instruct a gaming device to feature an attract mode for a particular game. The central controller may provide instructions as to how to run an entirely new game. For example, the central controller may download to a gaming device software for operating a new game. Such instructions may include graphic or video data for display with the new game, instructions for generating an outcome, instructions for determining a payout associated with the outcome, and so on.

Applicants have recognized that the popularity of various games in a casino may wax and wane. At a given time, a game may be very popular. All gaming devices featuring that game may be in use, leaving other players disappointed at their inability to find an available gaming device with the game. Another game may be unpopular. Gaming devices featuring the unpopular game may go unutilized, making the gaming devices wasted assets for the casino. Casinos may attempt to swap out gaming devices that are unpopular for gaming devices that are popular. However, such a process may be slow, cumbersome, and expensive. Further, casino managers may be slow to recognize when one game has become unpopular, or when another game has become popular.

Various embodiments allow a central controller to periodically provide gaming devices in a casino with instruction sets. A central controller may provide a gaming device with a new instruction set in order to achieve one or more goals, such as attracting more players to the gaming device, increasing the average duration of player sessions at the gaming device, or improving the profitability of the casino as a whole. The central controller may monitor various inputs from the casino, such as from the gaming devices at the casino, in order to determine appropriate instruction sets to transmit. For example, the central controller, through monitoring, may determine that an increasing number of players at the casino are playing a particular game. The central controller may accordingly transmit instruction sets to gaming devices that do not already feature the game, to begin featuring the game. As another example, the central controller may determine that gaming devices featuring a particular attract mode have seen increased play. Accordingly, the central controller may transmit to other gaming devices instructions to begin featuring the attract mode.

As used herein, an instruction set may include any instruction, or set of instructions, that may be carried out by a gaming device, human, or other entity. An instruction set may include computer commands, software, and/or programs. An instruction set may include data for use by a device, such as graphic data for display by a device, or audio data for broadcast by a device. An exemplary instruction set is the software for operating a gaming device in accordance with the rules of a game, such as software for operating a gaming device in accordance with the rules of video poker game. Another exemplary instruction set is software for featuring an attract mode, such as software for displaying graphics and broadcasting sounds in a particular way so as to attract a player to a gaming device. An instruction set may also include instructions to feature a different game at a gaming device, without necessarily including the software for operating the gaming device in accordance with the rules of the game. For example, the software for operating the game may already be stored on the gaming device, but may not currently be in use. An instruction set may include a directive to a gaming device, or other device, to do something. For example, an instruction set may include a directive to immediately begin featuring a new attract mode (i.e., to immediately begin displaying graphics and broadcasting sounds in accordance with the new attract mode). However, in instruction set may include instructions on how to operate in accordance with the rules of a game without providing an immediate directive to begin featuring the game. For example, a particular gaming device that currently features a video poker game may receive an instruction set for operating in accordance with the rules of a reeled-slot game. However, the gaming device may receive no directives to immediately feature the reeled-slot game, and so may continue to feature the video poker game.

As used herein, the verb “feature” means to actively display, promote, broadcast, or operate in accordance with. For example, a gaming device that features a game may display graphics consistent with the game, may generate outcomes according to the rules of the game, may broadcast sounds consistent with the game, and so on. For instance, a gaming device that features a video poker game may, among other things, show graphical depictions of five cards on its display screen. A gaming device that features an attract mode actively operates in accordance with the attract mode, by e.g., display graphics and broadcasting sounds consistent with the attract mode. It should be noted that a gaming device may store (e.g., in memory) an instruction set for operating in accordance with a game, while not “featuring” the game. That is, a gaming device may be capable of operating in accordance with the rules of video poker even while currently operating in accordance with the rules of a reeled slot game. The gaming device does not therefore feature the video poker game, but does feature the reeled slot game.

As will be described further below, there are a number of circumstances that may trigger the central controller to transmit an instruction set to a gaming device. As an illustration, the central controller may transmit to a gaming device an instruction set for featuring a pyramid-themed game. The central controller may transmit such an instruction set if it is known that a player who enjoys the pyramid-themed game is in the vicinity of the gaming device. The central controller may transmit such an instruction set if the pyramid-themed game has seen an increased rate of play across the casino recently (e.g., in the last day, week, or month). The central controller may transmit such an instruction set if a player at the casino has recently won a large jackpot while playing the pyramid-themed game. Presumably, other players will now want to try the game. The central controller may transmit such an instruction set if a game developer has paid the central controller to have a new game tested on the casino floor. It will be appreciated that there are many other possible circumstances that may trigger the central controller to transmit an instruction set to a gaming device. Various triggering circumstances will be described further below.

As used herein, the terms “player tracking card” and “tracking card” may refer to a card carried by a casino customer, signifying the customer's membership in a casino program that provides customers with rewards. The player tracking card may contain identifying information for the customer. Such identifying information may include a unique number and the customer's name. The identifying information may be printed on the card and/or encoded on a magnetic strip contained on the card. A customer may insert his player tracking card into a gaming device or a peripheral connected to the gaming device while he plays. Customer identifying information from the card may be transmitted to the central controller via the casino's network. With his card inserted, the customer may receive credit from the casino for play at the gaming device. For example, the customer may receive complimentary points which are redeemable for merchandise.

As used herein, the term “success metric” refers to a standard by which an instruction set is determined to be successful. For example, an instruction set for featuring a particular attract mode may be determined to be successful based on the number of people that begin play at a gaming device while the gaming device is featuring the attract mode. For instance, the more people that begin play at the gaming device while the attract mode is featured, the more successful the instruction set for featuring the attract mode may be deemed. A success metric may thus refer to a standard of measurement, such as a number of people to begin play at a gaming device, an amount of profit earned by a gaming device, a number of wagers made at a gaming device, and so on. The central controller may use a success metric as a means to determine whether an instruction set should be transmitted to one or more gaming devices, or not. A success metric may assume a particular value, such as “ten people” (e.g., in reference to the number of people to begin play at a gaming device while an attract mode is featured), “$70” (e.g., in reference to the amount of profit made by a gaming device while at attract mode is featured), and so on. The value of a success metric may represent measurements taken from one or more gaming devices.

For example, the value of a success metric may represent the average number of people to play at each of ten gaming devices during a period of time when each of the ten gaming devices were featuring a particular attract mode. The value of success metric may also represent measurements taken from multiple different time periods. For example, the value of a success metric may represent a one-week average of the daily amount of profit made by a gaming device featuring a particular game. It will be appreciated that many other success metrics are possible, that many other values for the success metrics are possible, and that many other ways of taking measurements for success metrics are possible.

As used herein, the term “ambient conditions” may refer to the circumstances, surroundings, or context of a casino, player, gaming device, or other entity. Ambient conditions may include a noise level, level of customer traffic, a time, a day of the week, a weather situation, and so on. For example, ambient conditions at a gaming device may include a noise level that is audible at the gaming device, a smokiness of the air near the gaming device, and so on

In various embodiments, one or more gaming devices may feature a game or attract mode based on the preferences of a customer who is proximate to the one or more gaming devices. For example, a gaming device may feature a game called “California Gold” if a customer who enjoys the game is within twenty feet of the gaming device. In various embodiments, an identity of a customer is determined. For example, the central controller receives identifying information about the customer from a gaming device. A location of the customer is determined. The location may represent a particular room or area of a casino, or the location of a particular gaming device or block of gaming devices. A gaming device is selected based on the location of the customer. For example, a gaming device is selected such that the location of the gaming device is the same as, or proximate to the location of the customer. An instruction set is determined based on the identity of the customer. The instruction set is transmitted to the gaming device that has been selected. The instruction set may represent instructions for operating a gaming device in accordance with a game that is known to be preferred by the customer. Thus, for example, the central controller may locate a customer, select a gaming device that is near to the customer (and presumably likely to be noticed by the customer), and transmit to the gaming device an instruction set for a game preferred by the customer. The customer may thus be more likely to begin play at the gaming device.

In various embodiments, determining the identity of the customer includes determining a number associated with the customer, and matching the number with identifying information for the customer. The number may be a player tracking card number, such as a player tracking card number assigned to the customer. Identifying information for the customer may include the customer's name. The central controller may maintain a database such as the customer database 1900 that stores player tracking card numbers 1920 and corresponding customer names 1930. Thus, when the central controller receives a player tracking card number (e.g., from a gaming device on the casino floor), the controller may determine the customer's name. The central controller may also determine associated game preferences 1940, which may also be stored in the database.

In various embodiments, determining an identity of a customer includes receiving an image of the customer; and determining identifying information for the customer based on the image. For example, the central controller may receive an image of a customer from various cameras, such as security cameras, stored around the casino. The central controller may employ various image and/or facial recognition algorithms in order to identify the customer, e.g., through comparison to a pre-stored image of the customer. In various embodiments, determining a location of a customer includes determining a location of a camera from which the image of the customer originated. Thus, if a camera at a particular location in a casino captures an image of a customer, the customer may be assumed to be within, or proximate to the particular location.

In various embodiments, the location of a customer may be determined based on the location of another customer. For example, two friends, or a husband and wife may be assumed to remain close together at a casino. Thus, for example, the location of one spouse is likely also to be the location of the other spouse. In various embodiments, determining a location of a customer includes determining a second customer associated with the customer, and determining the location of the second customer. The location of the second customer may be determined through recognition of the second customer's image, or player tracking number.

In various embodiments, determining a location of the customer includes determining a second gaming device into which the customer has inserted a player tracking card, and determining a location of the second gaming device. For example, the customer may sit down at the second gaming device and insert his player tracking card. The second gaming device may transmit information stored on the player tracking card (e.g., the player tracking card number), back to the central controller. The central controller, knowing the location of the second gaming device, may infer the location of the customer. The central controller may then select a gaming device based on the location of the customer, as described above.

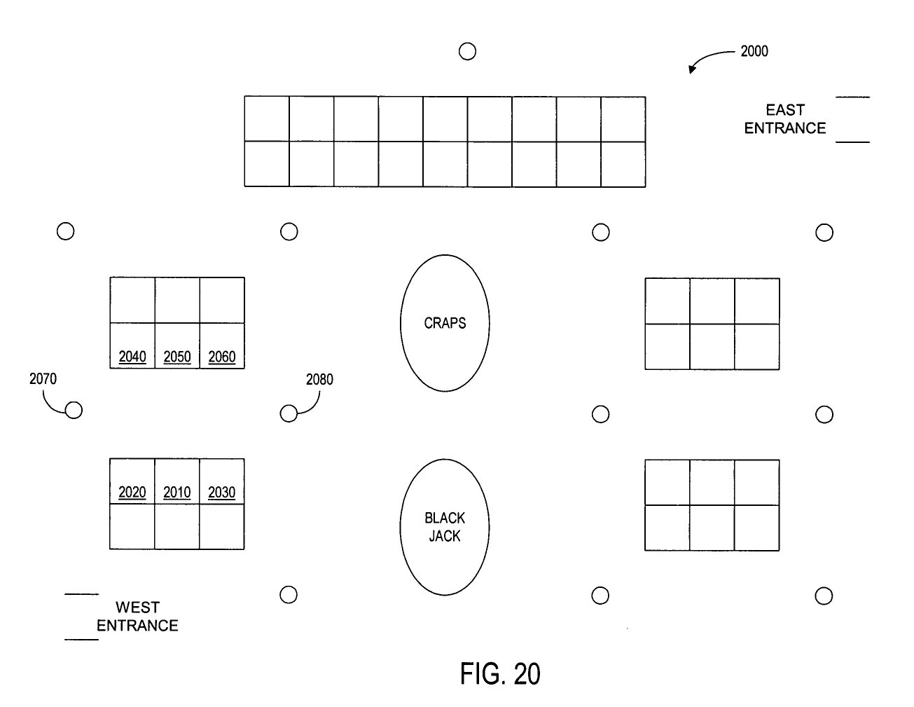

FIG. 20 is an exemplary diagram 2000 of the layout of a casino floor. The boxes, such as 2010 and 2020, represent gaming devices. The small circles, such as 2070 and 2080 represent cameras, such as security cameras. If an image of a customer is detected at camera 2070, for example, then the customer may be assumed to be near to camera 2070. As evident from the figure, the customer may be assumed to be near gaming devices 2010, 2020, 2030, 2040, 2050, and 2060. If the customer's image is detected at both cameras 2070 and 2080, then the customer's location may be inferred to an even greater accuracy (e.g., the customer may be inferred to be between cameras 2070 and 2080). Of course, the direction in which cameras face may also play a role in determining the location of a customer. For example, if a camera facing east detects the image of a customer, then the customer may be assumed to be east of the camera.

As mentioned above, a customer's location may also be determined through a determination of the location of a gaming device into which a customer has inserted a tracking card. Suppose the customer inserts his tracking card into gaming device 2010. The gaming device may indicate to the central controller that the customer has inserted his tracking card. The central controller may then look up the location of gaming device 2010 on diagram 2000. From the diagram, the central controller may determine that nearby gaming devices include gaming devices 2020, 2030, 2040, 2050, and 2060. Accordingly, the central controller may instruct the nearby gaming devices to, for example, feature an attract mode that is likely to draw the attention of the customer.

In various embodiments, determining a location of the customer may include receiving information about the customer's location from a casino employee. For example, the casino employee may recognize the customer and inform the central controller as to the customer's whereabouts.

In various embodiments, selecting a gaming device may include determining one or more gaming devices that are situated within a predetermined distance of the location of the customer, and selecting a gaming device from among the one or more gaming devices. The predetermined distance may be, for example, ten feet, twenty feet, or one hundred feet. Presumably, a customer may be more likely to see or notice gaming devices that are proximate to his current location. If the central controller is to attract a customer to a gaming device by having the gaming device feature a game preferred by the customer, the controller may be more successful in selecting a gaming device that is near to the customer than one that is far away.

In various embodiments, the customer's trajectory may be determined. For example, the customer's location may be determined in two places at two different times. The direction of the customer's travel may then be assumed to lie along the line connecting the first place and the second place. From the trajectory, or from other information, future locations the customer will visit may be extrapolated. Gaming devices in these future locations may then be selected to feature a game or attract mode that is suited to the customer's preferences.

In various embodiments, determining an instruction set includes determining instructions to promote a particular game. Promoting a game may include featuring video or audio from the game that is designed to make the game appealing or attractive to a passing customer.

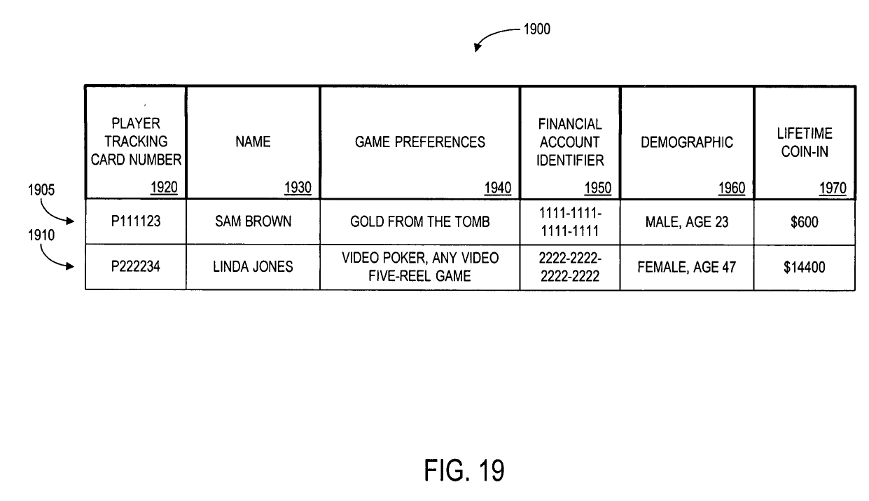

Various embodiments include determining a game preference associated with the customer. In such embodiments, determining an instruction set may include determining, based on the game preference, instructions to promote a particular game. A customer's game preference may be determined or inferred based on the customer's historical play. For example, the central controller may track the customer's play at a casino over a period of time. If the customer spends a predetermined amount of that time, or a predetermined proportion of the time, at a particular game, then it may be determined that the customer prefers that game. A customer's preferences may be determined or inferred to lie with a particular type of game. For example, a customer may have historically spent a large percentage of time playing bonus games. It may thus be inferred that a customer prefers to play bonus games. When the central controller (or other entity) determines instructions to promote a particular game, the particular game may be the game that is presumed to be preferred by the customer (e.g., the game that has been played by the customer historically for the greatest proportion of time). To continue the prior example, the central controller may provide instructions to a gaming device to promote a bonus game. As mentioned above, the games or types of games preferred by a customer may be stored in a customer database, such as the database 1900 of FIG. 19.

In various embodiments, determining an instruction set may include determining instructions to display a particular video clip. For example, the video clip may depict a graphic sequence from actual play of a game being promoted. In various embodiments, determining an instruction set may include determining instructions to broadcast a particular audio clip. For example, the audio clip may depict actual sounds from the play of a game being promoted. In various embodiments, determining an instruction set may include determining instructions to broadcast audio signals at a particular volume level. The central controller may instruct a gaming device to broadcast audio signals at various volumes depending on player characteristics (e.g., whether the player is hard of hearing), based on ambient sound levels (e.g., based on whether the sounds of other gaming devices are likely to drown out the broadcast sound), based on the player's current distance from the gaming device, and so on.

In various embodiments, determining an instruction set includes determining instructions to enable play of a particular game. For example, the central controller may provide a gaming device with software for operating in accordance with the rules of the particular game. The particular game may be a game known to be preferred by a customer.

In various embodiments, transmitting the instruction set includes transmitting the instruction set to the gaming device via a network. For example, the central controller and the gaming device may be in communication via a network, such as a local area network. The central controller may communicate the instruction set to the gaming device via the network.

In various embodiments described herein, it should be noted that a gaming device may be selected for featuring a game or attract mode in order to attract a customer even when the customer has not previously engaged in play at that particular gaming device. For example, the central controller may select a gaming device that is next to a gaming device played by the customer. In various embodiments, an identity of a customer is determined. A location of the customer is determined. A gaming device is selected based on the location of the customer, in which the customer has not selected the gaming device for play. An instruction set is determined based on the identity of the customer. The instruction set is transmitted to the gaming device.

In various embodiments, it should be noted that a customer need not provide his identity to a first gaming device in order that the first gaming device feature a game preferred by the customer. For example, the customer may provide his identity to a second gaming device proximate to the first gaming device. The central controller may then instruct the first gaming device to feature a game preferred by the customer. The customer may never have played at the first gaming device. However, since the central controller is able to identify the customer at the second gaming device, and to determine that the first gaming device is located near the second gaming device (e.g., using a diagram of a casino layout, such as diagram 2000), the central controller is able to instruct the first gaming device to feature a game appropriate for the customer. In various embodiments, an identify of a customer is determined. A location of the customer is determined. A gaming device is selected based on the location of the customer, in which the customer has not identified himself to the gaming device nor has the customer selected a game at the gaming device. An instruction set is determined based on the identity of the customer. The instruction set is transmitted to the gaming device.

In various embodiments, two customers may be in the same area of a casino. For each customer, there may be a different instruction set that would appropriately dictate the operations of a gaming device in the area. For example, the customers may have different game preferences. Accordingly, in various embodiments, it must be determined which of two competing instruction sets are to be executed by a gaming device. The two competing instruction sets may represent software for operating different games. In various embodiments, an identity of a first customer is determined, in which the first customer is located in proximity to a gaming device. An identity of a second customer is determined, in which the second customer is located in proximity to the gaming device. A first instruction set is determined based on the first customer. For example, a first instruction set for display of an attract mode for a game that is known to be preferred by the first customer is determined. A first effectiveness with which the first customer would be drawn to the gaming device should the gaming device execute the first instruction set is determined. The first effectiveness may represent a probability, likelihood, anticipation, or other measure. For example, the first effectiveness may represent a probability that is derived from historical data of customers who exhibit characteristics similar to the first customer, and who are drawn to gaming devices operating in accordance with the first instruction set. A second instruction set is determined based on the second customer. A second effectiveness with which the second customer would be drawn to the gaming device should the gaming device execute the second instruction set is determined. A third instruction set is determined based on the first effectiveness, the second effectiveness, the first instruction set, and the second instruction set. The third instruction set is transmitted to the gaming device. For example, the third instruction set may be chosen from the first instruction set and the second instruction set based on which has the greater effectiveness at drawing the corresponding customer to the gaming device. Thus, for example, if the first effectiveness is greater than the second effectiveness, the first instruction set may be chosen.

In various embodiments, an instruction set may include software for displaying advertisements for businesses within the casino, such as casino shows or restaurants, or for displaying advertisements for third party merchants. An instruction set may include software for displaying offers of discounts at a merchant. The central controller may transmit an instruction set for featuring an advertisement or other promotion, based on an anticipated likelihood with which a customer might respond to the promotion. For example, if a given customer is known to be near a gaming device, and the customer is known to enjoy gourmet food, then the central controller may provide the gaming device with an instruction set for displaying an advertisement for the casino's new gourmet restaurant.

To effectively draw a customer to a gaming device, the central controller may learn the customer's preferences in games. In various embodiments, a selection of a game is received from a customer. The customer may indicate a selection of a game by, for example, inserting his player tracking card into a gaming device that features the game. The customer may also indicate his preference by choosing a game, e.g., from a menu of available games, once he has sat down at a gaming device. A customer may indicate his preference for a game in many other ways. For instance, a casino employee may watch the customer stare at a game for an extended period of time. The casino employee may then report the customer's presumed interest in the game to the central controller. Identifying information for the customer is determined. For example, the central controller may determine the customer's identity from a tracking card that the customer has inserted into a gaming device. Of course, the gaming device may also make the determination. An indication of the game is stored in association with the identifying information, e.g., in field 1940 of customer database 1900.

Once a customer's preferences have been learned, a gaming device in the vicinity of the customer may be instructed to change its operations based on the customer's preferences. For example the gaming device may be instructed by the central controller to feature a game that the customer enjoys playing. In various embodiments, a location of the customer is determined. For example, a customer's location may be determined based on the location of a camera that has captured an image of the customer, or based on a location where the customer has inserted his player tracking card. In various embodiments, a gaming device is selected based on the location of the customer, in which the customer has not identified himself to the gaming device nor has the customer selected a game at the gaming device. For example, a gaming device is selected that is within ten feet of the customer, but is not a gaming device that the customer is currently playing. An instruction set is determined based on the game that the customer had previously selected, e.g., when the customer's preference in games was first determined. The instruction set may include instructions to feature the game. In this way, the selected gaming device may feature a game that is preferred by the customer. The instruction set is transmitted to the selected gaming device. In some embodiments, it may be preferable not to select a gaming device the customer is currently playing. If the gaming device currently being played by the customer were to begin operating in a different manner, the customer's current play might become interrupted.

In various embodiments, a customer's preferences may be determined from the customer's play of a game. In various embodiments, identifying information for a customer is determined. Identifying information may include a name, player tracking card number, or other identifying code. A game that has been played by the customer may be determined. For example, the central controller may determine that the customer has played Texas Tea during his present visit, or that the customer has played Wheel Of Fortune® during a prior visit. An indication of the game is stored in association with the identifying information. For example, an indication of the game is stored in field 1940. In various embodiments, determining a game may include determining a game that has been played by the customer for at least a predetermined period of time. For example, the central controller may determine that Texas Tea is a game preferred by the customer only if the customer has spent at least two hours playing the game in the past. In various embodiments, determining a game may include determining a game in which the customer has won at least a predetermined amount of money. For example, a customer may be presumed to like a game if he has won one hundred dollars in the game.

In various embodiments, two or more games, gaming devices or types of gaming devices may garner interest from the same customer base. For example, a customer who plays a game called Buried Treasure may play a game called Pirate's Land. A customer who plays one type of video-reel gaming device may also play other types of video-reel gaming devices. A customer who plays a gaming device with bonus rounds may also other gaming devices with bonus rounds. The central controller, for example, may track patterns of play among various customers. The controller may record correlations among two types of gaming devices in the sense that a relatively high percentage of players that play one of the two types of gaming devices also play the other of the two types of gaming device. For example, if 35% or more of the players that play a first type of gaming device also play a second type of gaming device, then the central controller may store an indication that the first type of gaming device and the second type of gaming device may be of interest to the same players. Subsequently, when a player plays the first type of gaming device, the central controller may instruct a nearby gaming device to feature a game present in the second type of gaming device. In another example, suppose that 53% of players who play the game Dragon's Lair also play the game Aladdin's Lamp. If a player play's the game Dragon's Lair at a first gaming device, the central controller may assume that the player may also enjoy Aladdin's Lamp. Therefore, the central controller may instruct a second gaming device near to the first gaming device to feature Aladdin's Lamp.

In various embodiments a customer's play may be monitored. If the customer plays a first game and then a second game, then the two games may be associated with one another. In various embodiments, a first game played by a first customer is determined. The first game may be a game that the customer has played at all. The first game may also be a game that the customer has played at least a predetermined amount of time, e.g., one hour. For example, after one hour, it may be assumed that the customer likes the game. A second game played by the first customer is determined. For example, the second game may be a game different from the first game. The first game is associated with the second game. The central controller may, for example, associate the first game with the second game. For example, the central controller may create a record in a database and populate two fields of the record, one field with the name of the first game, and another field with the name of the second game. The central controller can subsequently look up the first game in the database and find that the second game is associated with the first game.

In various embodiments, it may be further determined that the first game is played by a second customer. A location of the second customer may be determined. A gaming device may be selected based on the location of the second customer. For example, a gaming device may be selected that is proximate to the second customer. Instructions may be transmitted to the gaming device to feature the second game. The gaming device, in featuring the second game, may draw the second customer to it for the same reasons that other customers who enjoyed the first game also enjoyed the second game.

In various embodiments, common characteristics of games may be determined. The games may then be associated with one another. Subsequently, a customer who plays games with a given set of characteristics may be presumed to have a good chance of enjoying other games with similar characteristics.

In various embodiments, a first game played by a customer is determined. A characteristic associated with the first game is determined. A second game is determined, in which the characteristic is also associated with the second game. A location of the customer is determined. A gaming device is selected based on the location of the customer. Instructions to feature the second game are transmitted to the gaming device.

There are many characteristics that may be associated with the first game, or with any game. The characteristics may apply to the game itself and/or to the gaming device featuring the game. The characteristic may be the presence of a bonus round. The characteristic may be the presence of a progressive jackpot. The characteristic may be a high win frequency. The characteristic may be a high payback percentage. The characteristic may be the rendering of outcomes using video reels. The characteristic may be the rendering of outcomes using mechanical reels. The characteristic may be the ability for the player to make decisions affecting the game. The characteristic may be a low win frequency, a high standard deviation in the payout, a high (or low) maximum payout, a box design (e.g., round top or square top), and so on. Where a characteristic tends to be associated with a gaming device, rather than a particular game (e.g., the box design of the gaming device), a gaming device may be selected based on this characteristic. The selected gaming device may then be instructed to feature an attract mode that may draw the attention of the customer. For example, if the customer has, in the past, played predominantly at gaming devices with round tops, a gaming device proximate to the customer, and having a round top, may be selected. The gaming device may be instructed to feature an attract mode using loud sound effects, so as to draw the attention of the customer.

In various embodiments, a gaming device may receive an instruction set to feature an attract mode based on the results of a customer's play at another gaming device or set of gaming devices. For example, a gaming device may receive instructions for featuring a first attract mode if a customer at a nearby gaming device has been on a winning streak. The gaming device may receive instructions for featuring a second attract mode if a customer at a nearby gaming device has been on a losing streak.

For example, suppose a customer has just lost $40 in twenty minutes playing at a gaming device. The central controller may instruct a gaming device next to the gaming device of the customer to feature a certain attract mode. The attract mode may include the display of a message promising “at least one hour of play for only $20.” The attract mode may catch the customer's attention because, having lost $40 so quickly, the customer may wish to find a gaming device where his money will last a bit longer. Of course the gaming device seeking to attract the customer may also feature a game that lives up to the message of the attract mode. In other words, the game may be a game with a high payback percentage, high frequency of winning outcomes, and a low required bet.

In various embodiments, a first location of a first gaming device is determined. The first gaming device may be a gaming device currently being played by a customer. A second gaming device is selected based on the location of the first gaming device. An outcome of a handle pull at the first gaming device is determined. In various embodiments a set of symbols may be determined. In various embodiments, a payout may be determined. In various embodiments, a difference between an amount wagered and a payout may be determined. The outcome may be categorized as a “winning outcome,” “losing outcome,” “jackpot outcome”, or as some other category of outcome. The category of outcome may provide a basis for determining an instruction set to be executed by the second gaming device. In various embodiments, an instruction set is determined based on the outcome of the handle pull. In various embodiments, the instruction set is transmitted to the second gaming device. The second gaming device may then execute the instruction set.

In various embodiments, determining the outcome may include determining a set of outcomes at the first gaming device. For example, the central controller may determine a set of ten or twenty outcomes, or a set of outcomes that were generated over the course of an hour. The central controller may determine payouts associated with each of the outcomes, symbols associated with each of the outcomes, or a net payout associated with all of the outcomes (e.g., a total amount won for the set of outcomes minus the total amount wagered for the set of outcomes). Determining an instruction set may then include determining an instruction set based on the set of outcomes. For example, a first instruction set may be determined if the set of outcomes is associated with a net loss, while a second instruction set may be determined if the set of outcomes is associated with a net win.

In various embodiments described above, selecting a second gaming device includes selecting a second gaming device that is near to the location of the first gaming device. For example, the second gaming device may be in the same row of gaming devices as the first gaming device. The second gaming device may be next to the first gaming device, or within a certain number of gaming devices of the first. The second gaming device may be across from the first gaming device. In various embodiments, the second gaming device may be situated in such a way that there is a reasonable chance that a customer at the first gaming device would see or notice an attract mode or game that is featured on the second gaming device.

In various embodiments, determining an instruction set may include determining instructions to feature a particular game. In various embodiments, determining an instruction set may include determining instructions to promote a particular game. For example, the instruction set may instruct a gaming device executing the instruction set to depict graphics from the game. In various embodiments, determining an instruction set may include determining instructions to promote a particular payback percentage. For example, a high payback percentage of the second gaming device may be promoted in order to attract a player at the first gaming device. The promotion may including displaying the payback percentage in large font. In various embodiments, determining an instruction set may include determining instructions to promote a particular win frequency. In various embodiments determining an instruction set includes determining instructions to promote a recent occurrence. The recent occurrence may be the recent occurrence of a jackpot win. For example, the second gaming device may have generated a jackpot-winning outcome within the last hour.

In various embodiments described above, determining an instruction set may include determining a first instruction set if the outcome is a winning outcome, and determining a second instruction set if the outcome is a losing outcome. For example, the second gaming device may promote a first game if an outcome of the first gaming device is a winning outcome, but may promote a second game if the outcome of the first gaming device is a losing outcome. A player who has just won may be attracted by a different promotion than a player who has just lost. For example, a player who has just achieved a winning outcome may be attracted by a promotion for a large jackpot that is possible at the second gaming device. The player may be feeling lucky and wish to go for a large jackpot. On the other hand, a player who has just lost may be more attracted by a gaming device that promises greater win frequency.

In various embodiments, the central controller may measure the success of an instruction set. For example, the central controller measures the average amount of time it takes for a gaming device to attract a player when the gaming device is executing an instruction set for featuring a particular attract mode. If the average time is below a certain threshold, the instruction set may be deemed successful. Otherwise, the instruction set may be deemed unsuccessful. Based on the success of an instruction set, the central controller may transmit the instruction set to more or fewer gaming devices. For instance, a successful instruction set may be transmitted to more gaming devices, while an unsuccessful instruction set may no longer be transmitted to any gaming devices.

In various embodiments, an instruction set is transmitted to a first gaming device. The instruction set may be an instruction set for featuring an attract mode, an instruction set for featuring a game, or an instruction set for carryout out any other function. A value of a success metric may be determined for the instruction set based on customer use of the first gaming device. Based on the value of the success metric, the instruction set may be transmitted to a second gaming device. The instruction set may be transmitted to the second gaming device if and only if the value of the success metric exceeds a predetermined threshold. For example, if the success metric measures the average number of handle pulls played per hour at a gaming device featuring a particular game, then an instruction set for featuring the game may be transmitted to the second gaming device only if the value of the success metric (in this case, the average number of handle pulls per hour) exceeds a predetermined threshold of three hundred handle pulls per hour.

In various embodiments, determining a value of a success metric includes determining a value based on the number of wagers made at the first gaming device during a predetermined period of time in which the first gaming device was executing the instruction set. For example, the success metric may measure the number of wagers made at the first gaming device during the period in which the first gaming device was executing the instruction set. Exemplary values of the success metric may include “100 wager,” “259 wagers,” or “0 wagers.” In various embodiments, a larger number of wagers may serve as an indication of greater success.

In various embodiments, determining a value of a success metric includes determining a value based on the profit made by the first gaming device during a predetermined period of time in which the first gaming device was executing the instruction set. For example, the success metric may be a measure of the profit made by the first gaming device between 8:00 am and 9:00 am, while the first gaming device was executing the instruction set. Exemplary values of the success metric may include “$40,” “$20,” or “−$39”. In various embodiments, a larger profit (i.e., a higher value of the success metric) may serve as an indication of greater success.

In various embodiments, determining a value of a success metric includes determining a value based on the time that the first gaming device was in use during a predetermined period of time in which the first gaming device was executing the instruction set. For example, the success metric may be a measure of the number of minutes that the first gaming device was being played by a customer between 8:00 am and 9:00 am, while the first gaming device was executing the instruction set. Exemplary values of the success metric may include “0 minutes,” “20 minutes,” or “58 minutes.” In various embodiments, a larger number of minutes played (i.e., a high value of the success metric) may serve as an indication of greater success.

In various embodiments, determining a value of a success metric includes determining a value based on the number of people to use the first gaming device during a predetermined period of time in which the first gaming device was executing the instruction set. For example, the success metric may measure the number of people who made at least ten handle pulls at the gaming device between 9:00 am and 12:00 pm, while the first gaming device was executing the instruction set. Exemplary values of the success metric may include “0 people,” “3 people,” or “five people.” In various embodiments, a greater number of people may serve as an indication of greater success.

In various embodiments, determining a value of a success metric includes determining a value based on the total amount wagered at the first gaming device during a predetermined period of time in which the first gaming device was executing the instruction set. For example, the success metric may measure the total amount wagered between 9:00 am and 12:00 pm, while the first gaming device was executing the instruction set. Exemplary values of the success metric may include “$120,” “$1500,” or “400 coins.” In various embodiments, a larger number of wagers may serve as an indication of greater success.

It will be appreciated that in various embodiments, a success metric may measure many other types of data. In some embodiments, a success metric may measure the average length of play sessions for customer who play at the first gaming device while the first gaming device is executing the instruction set. A greater average length of a session may serve as an indication of greater success. In some embodiments, a success metric may measure the theoretical win at the first gaming device while the first gaming device is executing the instruction set.

In various embodiments, a success metric may measure the success of the first gaming device relative to a third gaming device, in which the first gaming device executes the instruction set while the second gaming device does not. Thus, for example, the success metric may measure the difference between an amount of profit earned by the first gaming device and an amount of profit earned by the third gaming device, during a particular period of time. A measure of relative success may more readily screen out influences that tend to affect all gaming devices. For example, blizzard conditions may exist on a particular day, keeping almost all players away from a casino. During such conditions, a lack of play at the first gaming device should not necessarily be interpreted as a lack of success of the instruction set being executed by the first gaming device. Comparisons with the third and/or with other gaming devices may reveal that all gaming devices are receiving relatively little play during a particular day.

In various embodiments, the central controller may have the opportunity to transmit multiple instruction sets to a gaming device. The central controller may select the instruction set from among the multiple instruction sets that has the highest associated value of a success metric. For example, the central controller may have the opportunity to instruct a gaming device to feature a first game or a second game. The central controller may then instruct the gaming device to feature the game with the higher associated value of a success metric.

In various embodiments, a first value of a success metric is determined, the first value associated with a first instruction set. For example, the first instruction set may represent instructions for featuring a first game. The success metric may measure, for example, the average number of wagers made per hour at gaming devices featuring a game. Thus, the first value may be two hundred fifty-eight, for example, and may represent the average number of wagers made per hour at gaming devices executing the first instruction set (e.g., featuring a the first game). In various embodiments, a second value of the success metric is determined, the second value associated with a second instruction set. For example, the second instruction set may represent instructions for featuring a second game (e.g., a game other than the first game). The second value may be, for example, one hundred ninety-six (wagers per hour). In various embodiments, it is determined whether the first value is greater than the second value. The first instruction set is transmitted to a gaming device if the first value is greater than the second value. To continue with the prior example, since the first value of two hundred fifty-eight (wagers per hour) associated with the first instruction set is greater than the second value of one hundred ninety-six associated with the second instruction set, the first instruction set may be transmitted to a gaming device to be featured. Presumably, the first instruction set is more successful. Therefore, the central controller is providing the gaming device with the first instruction set (as opposed to the second) because the central controller seeks, in this case, to propagate instructions sets that are most successful. Of, course, it will be appreciated that the central controller need not transmit the first instruction set to the gaming device. Rather, in embodiments where the gaming device already stores a copy of the first instruction set, the central controller need only transmit to the gaming device instructions to begin executing the first instruction set. It will also be appreciated that the central controller may transmit the first instruction set to multiple gaming devices. Further, it will be appreciated that the central controller may transmit the first instruction set to some gaming devices, and the second instruction set to other gaming devices. However, the central controller may transmit the first instruction set to more gaming devices than the second instruction set is transmitted to, since the first instruction set does have the higher associated value of the success metric.

In various embodiments, the central controller may test various instruction sets by transmitting them to various gaming devices, and determining values of a success metric for each of the instruction sets. The central controller may then use such values to determine which of the various instruction sets are successful, and/or which are the most successful.

In various embodiments, a single instruction set may be tested at multiple gaming devices. In various embodiments, an instruction set is transmitted to each of a first set of gaming devices. A value of a success metric is determined for the instruction set based on customer use of the gaming devices of the first set of gaming devices. Based on the value of the success metric, the instruction set is transmitted to a gaming device other than a gaming device of the first set of gaming devices.

In various embodiments, a gaming device may determine whether to execute an instruction set based on a value of a success metric determined at that gaming device. For example, a gaming device may determine the average length of time it takes for a new customer to begin play when a particular attract mode is featured. Based on the average length of time (the value of the success metric), the gaming device may determine whether to continue featuring the attract mode. Thus, a gaming device may “learn” which instruction sets are most successful without input from the central controller.

In various embodiments, an instruction set is executed at a gaming device during a first time period. For example, a particular game is featured from 9:00 pm to 10:00 pm. A value of a success metric is determined based on customer use of the gaming device during the first time period. Then, based on the value, it is determined whether to execute the instruction set over a second time period. For example, suppose the success metric measures the total amount wagered at the gaming device, and the value of the success metric is $400. The value of $400 may be compared to a threshold value (e.g., $300). In this example, the value of the success metric exceeds the threshold value, so the gaming device may determine to execute the instruction set over a second time period, such as 10:00 pm to 11:00 pm. Various embodiments may further include executing the instruction set over the second time period.

In various embodiments, an instruction set is executed at a gaming device during a first time period. A value of a success metric is determined based on customer use of the gaming device during the first time period. Then, based on the value, a frequency with which to execute the instruction set is determined. Thus, for example, an instruction set with a relatively low value of a success metric may still be executed from time to time. However, in general, an instruction set with a relatively low value of a success metric may tend to be executed less frequently than is an instruction set with a relatively high value of the same success metric (or even of a different success metric). For example, in instruction set for featuring a first game may be executed for a three-hour period once every day, while an instruction set for featuring a second game may be executed for a three-hour period once every week. This may be because the first instruction set has a higher associated value of a success metric than does the second instruction set. Of course, a gaming device may determine a duration with which to execute an instruction set based on a value of an associated success metric. For example, rather than executing more frequently an instruction set with a high value of an associated success metric, a gaming device may execute the instruction set for a longer period of time at a stretch. Of course, a gaming device may determine both the frequency and duration over which an instruction set is to be executed based on the value of an associated success metric.

In various embodiments, an instruction set is executed at a gaming device during a first time period. A value of a success metric is determined based on customer use of the gaming device during the first time period. Then, based on the value, a probability with which to execute the instruction set is determined. In various embodiments, the higher the value of the success metric, the greater the probability (up to a maximum of probability one) with which the instruction set is executed. The gaming device may periodically make a determination as to whether the instruction set might be executed. The gaming device may then determine at random, but subject to the aforementioned probability, whether to actually begin executing the instruction set.

In various embodiments, the central controller may monitor the success of an instruction set at a given gaming device. For example, the central controller may determine a value of a success metric associated with an instruction set being executed at the gaming device. Based on the value of the success metric, the central controller may instruct the gaming device as to whether to continue executing the instruction set, as to whether to increase or decrease the frequency with which the instruction set is executed, as to whether to increase or decrease the probability with which the instruction set is executed, and so on.

In various embodiments, a value of a success metric is determined based on customer use of a gaming device during a first time period. A determination is made, based on the value, as to whether to execute the instruction set over a second time period. A signal is then transmitted to the gaming device to execute the instruction set over the second time period. For example, the determination may have been resolved in the affirmative, thus resulting in the signal being transmitted.

In various embodiments, a gaming device or central controller may determine an instruction set to be executed by the gaming device based on ambient conditions. For example, there may be several methods for promoting a gaming device. One method may emphasize visual means. For example, one attract mode may emphasize flashy graphics to attract players to play the gaming device. A second method may emphasize audio. For example, a second attract mode may emphasize loud or appealing sounds to attract players to play the gaming device. If ambient conditions are noisy (e.g., the general sound level in the casino in the are of the gaming device is noisy), then the attract mode emphasizing flashy graphics may be emphasized, since the graphics are not diminished by ambient sound levels. If, however, the ambient noise level is low, then the attract mode that emphasizes sounds may have a better chance of catching players' attention.

In various embodiments, a set of ambient conditions are determined. Based on the set of ambient conditions, a first method of promoting a gaming device is determined. The first method of promoting the gaming device is then implemented. For example, the method of promoting the gaming device may include having the gaming device feature an attract mode. Implementing the first method of promotion may include having the gaming device execute an instruction set for featuring the attract mode.

Ambient conditions may include at least one of: a noise level; a time of day; a day of the week; and a proximity of a customer. Ambient conditions may include the state of the weather (e.g., sunny, cloudy, cold), the crowdedness of a casino, the smokiness of a casino, the temperature of a casino, and so on. Ambient conditions may be determined in a number of ways. A gaming device may include one or more sensors. For example, a gaming device may include a microphone for detecting ambient noise levels. A gaming device may include a smoke detector for detecting the smokiness of a casino. A gaming device may contain a thermometer for detecting ambient temperatures. Of course, one or more sensors may be separate from one or any gaming device. For example, the central controller may determine ambient temperatures via a thermometer with which it is in communication. A gaming device and/or the central controller may include internal clocks or calendars for determining a time or date. The central controller and/or a gaming device may receive automatic feeds from weather services in order to determine weather conditions.

In various embodiments, determining a method of promoting a gaming device may include determining, based on the set of ambient conditions, from among at least one of: a text-based method of promoting the gaming device; a graphics-based method of promoting the gaming device; and an audio-based method of promoting the gaming device.

In various embodiments, a second method of promoting the gaming device is determined, in which the second method is not the first method. Thus, a gaming device may be capable of using multiple methods of promotion, depending on ambient conditions. A gaming device may switch from one method of promotion to another as ambient conditions change.

It will be appreciated that a gaming device may execute or not execute any given instruction set based on ambient conditions. For example, a gaming device may feature a first game if the time is between 12:00 am and 6:00 am, and a second game if the time is between 6:00 am and 10:00 am.

In various embodiments, a gaming device may or may not feature a particular game based on the utilization of other gaming devices in the casino. For example, suppose that all gaming devices featuring the game “Sunken Treasure” are currently being played by casino customers. Presumably, Sunken Treasure is a popular game. It may be likely that there is additional demand by customers to play Sunken Treasure. However, such customers may be unable to play the game because all gaming devices featuring the game are in use. Accordingly, the central controller may select a gaming device that does not currently feature Sunken Treasure. The central controller may transmit an instruction set to the gaming device to feature the game Sunken Treasure. The central controller may thereby increase the availability of the Sunken Treasure games to casino patrons.

In various embodiments, certain games may experience low rates of play from casino customers. Presumably, such games are unpopular. Accordingly, the central controller may transmit instructions to one or more gaming devices featuring the games to cease featuring the games and/or to begin featuring other games. In this way, a casino as a whole can constantly, dynamically, and/or automatically adjust the availability of games on the casino floor to suit customer demand.

In conventional casinos, unpopular gaming devices are eventually removed from the casino floor. If a gaming device is popular, more similar gaming devices are placed on the casino floor. However, the process of addition and removal can be very slow, cumbersome, and ad hoc. The mere difficulty of disconnecting, lifting, and transporting gaming devices makes it very difficult to quickly adjust and readjust the game selection on a casino floor. In addition, casino managers may be slow or inaccurate in recognizing the popularity or unpopularity of a game. For example, casino managers may recognize the unpopularity of a game based on their own observations, or based on summary financial reports issued relatively infrequently.

In contrast, various embodiments of the present invention may allow much more rapid adjustment of game selection and more accurate detection of a games' popularity or unpopularity, or other measure of success. Furthermore, various embodiments of the present invention may avoid the necessity of constantly replacing gaming devices themselves, saving the costs of the devices and of the labor involved in transporting them.

In various embodiments, a number of gaming devices at which a game is being played is determined. For example, the central controller may determine the number of gaming devices at which Sunken Treasure is being played. The phrase “being played” may refer to a gaming device in which a player currently has a balance, a gaming device in which a player currently has a player tracking card inserted, a gaming device at which a wager has been made in the last thirty seconds, a gaming device at which an outcome has been generated in the last thirty seconds, and/or a gaming device at which any other indication of customer gambling activity is present. A gaming device at which the game is not being played is selected. For example, a gaming device that does not currently feature the game Sunken Treasure is determined. Then, based on the number exceeding a predetermined threshold, instructions to feature the game are transmitted to the selected gaming device. For example, if the number of gaming devices at which Sunken Treasure is being played exceeds a threshold of fifty gaming devices, then instructions to feature Sunken Treasure may be transmitted to the selected gaming device. In this way, for example, Sunken Treasure may be made more readily available to players who may want to play, but cannot find an unoccupied gaming device featuring Sunken Treasure. Note that when providing the selected gaming device with instructions to feature Sunken Treasure, the central controller may transmit to the selected gaming device an instruction set for operating in accordance with the game Sunken Treasure. However, if the selected gaming device already has a stored copy of the instruction set, then the central controller need not necessarily transmit a new copy of the instruction set to the selected gaming device. Rather, the central controller may instruct the selected gaming device to begin featuring Sunken Treasure.

In various embodiments, the central controller may determine how many gaming devices are available that would currently allow a player to play a particular game. If there are relatively few such gaming devices available, then the central controller may instruct one or more gaming devices not currently featuring the game, to begin featuring the game.

In various embodiments, a determination is made as to the number of gaming devices that exist at which a game is available for play, but is not currently being played. A gaming device at which the game is not available for play is selected. Based on the number falling below a predetermined threshold, instructions are transmitted to the selected gaming device to feature the game. For example, if there are fewer than five gaming devices (i.e., five is the threshold) on the casino floor at which the game is available for play (e.g., where the game is featured and where the gaming device is not currently being played), then the central controller may transmit instructions to the selected gaming device to feature the game. In various embodiments, instructions may be transmitted to the selected gaming device to promote the game. For example, instructions may be transmitted to the selected gaming device to feature an attract mode with video and audio clips from the game.

In various embodiments, the central controller may seek to determine the popularity of a game by examining the ratio of the number of such games available for play, to the number actually being played. For example, if there are fifty gaming devices featuring the game “Precious Stones”, and forty of them are in use, the ratio of forty in use to fifty available may indicate a high degree of popularity. Accordingly the central controller may instruct additional gaming devices to begin featuring the game Precious Stones.

In various embodiments, a determination is made as to a ratio of a first number of gaming devices at which a game is being played, to a second number of gaming devices at which the game is available for play. A gaming device at which the game is not available for play is selected. Based on the ratio exceeding a predetermined threshold, instructions to feature the game are transmitted to the selected gaming device. For example, if the ratio exceeds a predetermined threshold of 0.7:1, then instructions to feature the game may be transmitted. In various embodiments, based on the ratio exceeding a predetermined threshold, instructions to promote the game may be transmitted. It should be noted that the ratio may alternatively be expressed as a fraction, a percentage, a proportion, or in terms of any other suitable mathematical or other relationship.

In various embodiments, if there are a large number of gaming devices that currently feature a game, but are not being played, then the central controller may instruct such gaming devices to stop featuring the game. In various embodiments, if there is a small ratio of a number of gaming devices at which a game is available and which are being played, to a number of gaming devices featuring the game, then the central controller may instruct some of the gaming devices to stop featuring the game. Presumably, games for which such a ratio is small are unpopular, and may be more profitably replaced with other games.

In various embodiments, a first number of gaming devices at which a first game is being played is determined. A second number of gaming devices at which the first game is featured is determined. A ratio of the first number to the second number is determined. A gaming device is selected from among the second number of gaming devices that is not one of the first number of gaming devices. For example, a gaming device is selected that features the first game, but that is not currently being played. The selected gaming device is instructed to stop featuring the first game. In various embodiments, the selected gaming device is instructed to feature a second game in place of the first game. In various embodiments, each of the aforementioned second number of gaming devices is in a single casino. If all the gaming devices are in the same casino, then the ratio of the first number to the second number may serve as a reasonable indicator of the popularity of the first game in the casino. The casino may use the ratio as a way to rebalance the types of games that are currently on the casino floor so as to better suit the preferences of the population of casino customers currently on the floor.

In various embodiments, each of the aforementioned second number of gaming devices is in a single room of a casino. Thus, the casino may rebalance the types of games that are in a particular area of a casino to better suit the preferences of the population of the customers in that area. In various embodiments, each of the aforementioned second number of gaming devices is in a single location of a casino.

In various embodiments, third parties may have an interest in promoting their games at casinos. For example, a game developer may wish for casino customers to try one of the game developer's new games. If many customers like the new games, then the game developer may be able to convince the casino to buy or license the game from the game developer. Therefore, a third party may pay a casino to feature or promote a game.

In various embodiments, a third party is charged for an amount of time that its game was promoted. In various embodiments, an amount of time that a game was promoted at a gaming device is determined. A third party is charged an amount of money that is based on the amount of time. In various embodiments, the amount of money is proportional to the amount of time. In various embodiments the amount of money is collected from the third party. In various embodiments, the third party is a game developer.

In various embodiments the central controller (e.g., on behalf of the casino) may reach an agreement beforehand as to how much the third party will be charged when the casino features its games. In various embodiments, an agreement is reached with the third party on a rate. For example, the central controller may reach an agreement with the third party whereby the third part will pay ten cents per minute during which the third party's game is promoted on any given gaming device. Charging the third party may therefore include charging the third party an amount of money that is based on the rate and the amount of time that the third party's game is promoted. In various embodiments, charging the third party includes charging the third party an amount of money equal to the rate multiplied by the amount time. For example, if the rate is ten cents per minute, and the third party's game is promoted for a total of five hundred minutes, then the third party may be charged ten cents per minute times five hundred minutes, or $50.

In various embodiments, a third party's game may be featured by one or more gaming devices on a casino floor. The third party may be charged a fee based on the amount of time (or other measure) that the third party's game was actually played. In various embodiments, an amount of time that a game was played at a gaming device is determined. A third party is charged an amount of money based on the amount of time. For example, a third party may be charged $5 for every hour that its game is played at a given gaming device.

In various embodiments, a third party may be charged a rate for promoting or featuring its game, where the rate varies by time of day, day of the week, date of the month, and so on. For example a rate charged may be relatively low during early morning hours (e.g., from 2:00 am to 6:00 am) and relatively high in the late afternoon and evening (e.g., from 6:00 pm to 10:00 pm). Traditionally, relatively few people frequent casinos during the early morning hours, while the casino has its greatest traffic closer to the evening. Thus, rates may vary according to the expected customer traffic of a casino during a given period of time.

In various embodiments, an agreement is reached with a third party on a rate that applies during a first time period. For example, the central controller and third party may agree on a rate of twenty-five cents per minute to be charged to the third party in return for the promotion of its game between 6:00 pm and 10:00 pm. An agreement is reached with the third party on a rate that applies during a second time period. For example, the central controller and third party may agree on a rate of ten cents per minute to be charged to the third party in return for the promotion of its game between 8:00 am and 11:00 am. A first amount of time that the game was promoted during the first time period is determined. A second amount of time that the game was promoted during the second time period is determined. The third party is charged an amount of money based on the first rate, the second rate, the first amount of time, and the second amount of time. For example, the third party may be charged an amount of money equal to the first rate multiplied by the first amount of time plus the second rate multiplied by the second amount of time. The first time period may be a peak time period and the second time period may be an off-peak time period. A “peak” time period may refer to a time period where there is relatively high customer traffic, while an “off-peak” period may refer to a time period where there is relatively low customer traffic.

In various embodiments, a casino may benefit from promoting or featuring the game of a third party. For example, the game may receive a large amount of play and may therefore generate a large amount of profit for the casino. Accordingly, a casino may pay a third party for the amount of time that the third party's game is promoted. In various embodiments, an amount of time that a game was promoted at a gaming device is determined. A third party is paid an amount of money that is based on the amount of time.

In various embodiments, an amount of time that a game was played at a gaming device is determined. A third party is paid an amount of money that is based on the amount of time.

In various embodiments, a gaming device does not change the game that it features for a predetermined amount of time after the game has been played by a customer. A customer who has just played a game at a gaming device may wish to return to the gaming device and play again at some later point in time. If the customer were to return and find that the game he played was not featured, he might become confused or disappointed. Accordingly, once a customer has played a game at a gaming device, the same game may continue to be featured for at least a predetermined period of time, such as an hour, six hours, twenty-four hours, or a week.

In various embodiments an outcome is generated at a gaming device in accordance with a first game. This outcome may be generated in response to a wager and a “spin” command from a customer. The customer may be currently playing the gaming device. Then, an amount of time that has elapsed since the outcome was generated is determined. In various embodiments, this amount of time represents an amount of time since the outcome was generated, and during which no further outcomes were generated. Presumably then, the outcome may be considered to have been the last outcome of a customer's session. The amount of time may therefore represent an amount of time during which the gaming device has not been played. A determination is made as to whether the amount of time exceeds a predetermined threshold. The threshold may be fifteen minutes, one hour, one day, one week, or any other period of time. If the amount of time exceeds the threshold, then a second game may be featured in place of the first. In various embodiments, a second game may be promoted in place of the first. For example, an attract mode may show graphics from a second game in place of the first game.

In various embodiments, an amount of time that has elapsed since an outcome was generated at a gaming device is determined. A determination is made as to whether the amount of time exceeds a predetermined threshold. The gaming device is instructed to promote a second game in place of the first game if the amount of time exceeds the threshold. For example, the central controller may instruct the gaming device to promote the second game in place of the first game if the amount of time exceeds the threshold. The gaming device may also be instructed to feature a second game in place of the first game if the amount of time exceeds the threshold.

In various embodiments, it is desirable to measure the success of an attract mode. The success may be measured in various ways that will be described below. Measuring the success of an attract mode allows a determination to be made as to whether or not the attract mode should continue to be used and/or spread to other gaming devices. Measuring the success of any instruction set can have the same import.

In various embodiments, an instruction set is executed at a first gaming device during a time period. A value of a success metric for the instruction set is determined based on at least one of: the number of people who play at the first gaming device during the time period; the amount of money that is wagered at the first gaming device during the time period; the amount of profit that is made by the first gaming device during the time period; the amount of time that the first gaming device is being played during the time period; the amount of time that the first gaming device is idle during the time period; and the amount of time that the first gaming device is in use relative to the amount of time that a second gaming device is in use during the time period. The instruction set is transmitted to a third gaming device if the value of the success metric exceeds a predetermined threshold.

In various embodiments, a casino may decide to increase or decrease the number of gaming devices that feature a game based on the costs to the casino of featuring the game. Similarly, in various embodiments, a casino may decide to increase or decrease the amount of time or the frequency with which a game is featured based on the costs to the casino of featuring the game. For example, a casino may decide to feature a game on fewer gaming devices if the casino must pay a portion of profits derived from the game to the game's developer. The casino might prefer to feature a game for which the casino receives all profits.

In various embodiments a first price rate for featuring a first game is determined. The price rate may refer to the price per unit of time, per unit profit, or per other unit, that the casino must pay to the game's developer for featuring the game. For example, the price rate for a particular game may be twenty cents per dollar of profit that is made by the game. A second price rate for featuring a second game is determined. A determination is made as to which of the first game and the second game to feature based on the first price rate and the second price rate. For example, the first game may be featured at a particular gaming device if the first price rate is lower than the second price rate. However, the casino may account for other factors besides price rate. Thus, a casino may decide to feature the game with the higher price rate if the game also has a higher associated value of a success metric.

In various embodiments, the central controller may correlate the success of instruction set with ambient conditions that were present when the instruction set was executed. For example, a particular game may earn high profits for a casino during a particular time period. During that same time period, ambient conditions may include unseasonably hot weather outside. Therefore, in the future, when there is again unseasonably hot weather, the central controller may increase the number of gaming devices that feature the game.

In various embodiments, a determination is made as to the value of a success metric associated with the execution of an instruction set during a particular time period. For example, the value of a success metric is determined for the game “Emperor's Gold” for the period from 3:00 pm to 6:00 pm. A first set of ambient conditions during the first time period is determined. As described above, ambient conditions may include a noise level, a level of customer traffic, a smokiness, and so on. A second set of ambient conditions during a second time period is determined. The instruction set is transmitted to a gaming device if the value of the success metric exceeds a predetermined threshold and if the second set of ambient conditions is similar to the first set of ambient conditions. For example, suppose Emperor's Gold was found to be successful during the first time period. Suppose also that the casino was crowded during the first time period. Then, if the casino is also crowded during the second time period, the central controller may transmit the instruction set for Emperor's Gold to one or more gaming devices. Emperor's Gold may then be featured during the second time period.

In various embodiments, the central controller may coordinate the instruction sets that are sent to various gaming devices in order to create an overall effect in the casino. For example, the central controller may transmit instruction sets for featuring a particular game to a set of gaming devices that are located adjacent to one another. In this way, the central controller may create a location in a casino where customers know they can go to play the particular game. As another example, the controller may transmit instruction sets for featuring a particular game to a set of gaming devices that are far apart from one another. In this way, gaming devices featuring the game are not concentrated in one area, and more customers are likely to obtain exposure to the game. Of course, gaming devices may coordinate with one another via a common network. For example, a gaming device featuring a first game may communicate to two adjacent gaming devices that they should not also feature the first game.

While the present invention has been described above in terms of specific embodiments, it is to be understood that the invention is not limited to the disclosed embodiments. On the contrary, the present invention is intended to cover various modifications and equivalent structures included within the spirit and scope of the appended claims.

1. A method comprising:
transmitting an instruction set to a first gaming device;
determining a value of a success metric for the instruction set based on customer use of the first gaming device; and
transmitting, based on the value of the success metric, the instruction set to a second gaming device.

2. The method of 1 in which transmitting includes transmitting software for a game to a first gaming device;
in which determining includes determining an amount of profits made by the first gaming device while executing the software; and
in which transmitting includes transmitting the software to a second gaming device if the amount of profits exceeds $500.

3. The method of 2 in which transmitting the instruction set to a second gaming device includes transmitting the instruction set to a second gaming device if and only if the value of the success metric exceeds a predetermined threshold.

4. The method of 2 in which determining a value of a success metric includes determining a value based on the number of wagers made at the first gaming device during a predetermined period of time in which the first gaming device was executing the instruction set.

5. The method of 2 in which determining a value of a success metric includes determining a value based on the profit made by the first gaming device during a predetermined period of time in which the first gaming device was executing the instruction set.

6. The method of 2 in which determining a value of a success metric includes determining a value based on the time that the first gaming device was in use during a predetermined period of time in which the first gaming device was executing the instruction set.

7. The method of 2 in which determining a value of a success metric includes determining a value based on the number of people to use the first gaming device during a predetermined period of time in which the first gaming device was executing the instruction set.

8. The method of 2 in which determining a value of a success metric includes determining a value based on the total amount wagered at the first gaming device during a predetermined period of time in which the first gaming device was executing the instruction set.

9. A method comprising:
determining a first value of a success metric, the first value associated with a first instruction set;
determining a second value of the success metric, the second value associated with a second instruction set;
determining whether the first value is greater than the second value; and
transmitting the first instruction set to a gaming device if the first value is greater than the second value.

10. A method comprising:
transmitting an instruction set to each of a first set of gaming devices;
determining a value of a success metric for the instruction set based on customer use of the gaming devices of the first set of gaming devices; and
transmitting, based on the value of the success metric, the instruction set to a gaming device other than a gaming device of the first set of gaming devices.

11. A method comprising:
determining a set of ambient conditions;
determining, based on the set of ambient conditions, a first method of promoting a gaming device; and
implementing the first method of promoting the gaming device.

12. The method of 11 in which the set of ambient conditions include at least one of: a noise level; a time of day; a day of the week; and a proximity of a customer.

13. The method of 11 in which determining a first method of promoting a gaming device includes determining, based on the set of ambient conditions, from among at least one of: a text-based method of promoting the gaming device; a graphics-based method of promoting the gaming device; and an audio-based method of promoting the gaming device.

14. The method of 11 further including determining a second method of promoting the gaming device, in which the second method is not the first method.

15. A method comprising:
determining a number of gaming devices at which a game is being played;
selecting a gaming device at which the game is not being played; and
transmitting to the selected gaming device, based on the number exceeding a predetermined threshold, instructions to feature the game.

16. A method comprising:
determining a number of gaming devices at which a game is available for play, but not currently being played;
selecting a gaming device at which the game is not available for play; and
transmitting to the selected gaming device, based on the number falling below a predetermined threshold, instructions to feature the game.

17. A method comprising:
determining a ratio of a first number of gaming devices at which a game is being played, to a second number of gaming devices at which the game is available for play;
selecting a gaming device at which the game is not available for play; and
transmitting to the selected gaming device, based on the ratio exceeding a predetermined threshold, instructions to feature the game.

18. A method comprising:
determining a first number of gaming devices at which a first game is being played;
determing a second number of gaming devices at which the first game is featured;
determining a ratio of the first number to the second number;
selecting a gaming device from among the second number of gaming devices that is not one of the first number of gaming devices; and
instructing the selected gaming device to stop featuring the first game.

19. The method of 18 in which instructing includes instructing the selected gaming device to feature a second game in place of the first game.

20. The method of 18 in which each of the second number of gaming devices is in a single casino.

21. The method of 18 in which each of the second number of gaming devices is in a single room of a casino.

22. The method of 18 in which each of the second number of gaming devices is in a single location of a casino.

23. A method comprising:
executing, during a time period, an instruction set at a first gaming device;
determining a value of a success metric for the instruction set based on at least one of:
(i) the number of people who play at the first gaming device during the time period;
(ii) the amount of money that is wagered at the first gaming device during the time period;
(iii) the amount of profit that is made by the first gaming device during the time period;
(iv) the amount of time that the first gaming device is being played during the time period;
(v) the amount of time that the first gaming device is idle during the time period; and
(vi) the amount of time that the first gaming device is in use relative to the amount of time that a second gaming device is in use during the time period; and
transmitting the instruction set to a third gaming device if the value of the success metric exceeds a predetermined threshold.
